(19) United States
(12) Patent Application Publication
(10) Pub. No.: US 2025/0043906 A1
(43) Pub. Date: Feb. 6, 2025

(54) LOAD SUPPORT UNIT

(71) Applicant: MESO SCALE TECHNOLOGIES, LLC., Rockville, MD (US)

(72) Inventors: Manish KOCHAR, Rockville, MD (US); Gary KRIVOY, Rockville, MD (US); Aaron H. LEIMKUEHLER, Upper St Clair, PA (US)

(21) Appl. No.: 18/793,305

(22) Filed: Aug. 2, 2024

Related U.S. Application Data
(60) Provisional application No. 63/517,758, filed on Aug. 4, 2023.

(51) Int. Cl. F16M 13/02; F16M 11/14; F16M 11/20

(52) U.S. Cl. CPC F16M 13/02; F16M 11/14; F16M 11/2014; F16M 11/2021; F16M 2200/022

(57) ABSTRACT

The invention relates to a load support unit for holding and adjusting the orientation of the load. The load support unit includes a lower arm, a upper arm, a mounting swivel, a swivel joint, a knuckle joint and a rotational joint. The mounting swivel allows the load support unit to rotate relative to its surroundings, the swivel joint allows the upper arm to rotate relative to the lower arm, the knuckle joint allows the upper arm to pivot in a rotational direction relative to the lower arm, and the rotational joint allows the load to rotate about the upper arm.

### RELATED APPLICATIONS

This application claims priority under 35 U.S.C. § 119(e) to U.S. Provisional Application No. 63/517,758, filed on Aug. 4, 2023, the contents of which are incorporated herein by reference.

### FIELD OF THE INVENTION

The present invention generally relates to a load support unit.

### BACKGROUND

Systems, such as support arms, configured for supporting and/or extending a load above a surface, e.g., a desk, cart, or other surface, may be difficult to use, lack aesthetic beauty, and lack functionality. Due to the levered forces and moment arms involved, such support arms frequently provide limited load positioning, movement that is clunky, jerky, or otherwise lacking smoothness, and may be bulky.

It is therefore desirable to provide a load support unit configured to support and extend a load into a wide variety of positions while being highly functional, easy to use, and providing the ability for an aesthetically superior look. Systems and devices described herein provide such advantages.

### BRIEF SUMMARY OF THE INVENTION

In accordance with an embodiment hereof, a knuckle joint is configured for connecting a lower arm and an upper arm. The knuckle joint comprises an outer shell, a body sized and shaped to fit within an opening of the upper arm, and an actuator element. The actuator element includes a trigger button disposed exterior to the body and includes an engagement arm extending therefrom and into the body, at least one actuator pawl disposed within an interior surface of the body, a biasing spring configured to bias the engagement arm away from interaction with the at least one actuator pawl, and a spring element configured to bias the at least one actuator pawl towards the interior surface of the body. When the trigger button is engaged, the engagement arm interacts with the at least one actuator pawl such that the knuckle joint is in an unlocked configuration.

In accordance with an embodiment hereof, a swivel joint is configured to connect a lower arm and a upper arm. The swivel joint comprises an outer shell, a first tapered bushing having a first circumferential opening though a center thereof, a second tapered bushing having a second circumferential opening through a center thereof, and a shoulder screw. The first tapered bushing is rotationally keyed to the shoulder screw to prevent relative rotation with the shoulder screw and provide friction during relative rotation with the outer shell.

In accordance with an embodiment hereof, a mounting swivel is configured to support an arm. The mounting swivel comprises a base plate configured for coupling to the arm, a holder post that extends from the base plate, wherein the holder post includes at least one keyway, a base adapter configured to receive the holder post. The base adapter includes a base block, wherein the base block further includes at least one keyway, and a base socket extending from the base block. The mounting swivel further includes a friction stack including a plurality of clutch plates, a plurality of friction plates disposed between respective ones of the plurality of clutch plates, and a spring element. The base socket of the base adapter is configured to house the holder post of the lower arm. Rotation of the holder post causes conforming rotation of the plurality of friction plates relative to the plurality of clutch plates. The rotation of the plurality of friction plates relative to the plurality of clutch plates causes resistance to the rotation of the holder post.

In accordance with an embodiment hereof, a rotational joint is configured for supporting a load at an end of an arm. The rotational joint comprises a ball attachment including a rotator ball and a stem, and a socket configured to accommodate the rotator ball. The socket includes a first socket portion and a second socket portion. The rotational joint further includes a collar configured to secure the rotator ball within the socket, and a load support coupled to the first socket portion of the socket. The rotation of the rotator ball does not cause loosening of the collar. The socket, collar and load attachment connected thereto is able to rotate freely about the rotator ball attached to the arm.

In accordance with an embodiment hereof, a load support unit includes a lower arm, a upper arm, a mounting swivel configured to support the lower arm, a swivel joint disposed between the lower arm and a knuckle joint, the knuckle joint disposed between the swivel joint and the upper arm, an outer shell configured to house the swivel joint and the knuckle joint, and a rotational joint configured for supporting a load at the upper arm.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

The foregoing and other features and advantages of the present disclosure will be apparent from the following description of embodiments hereof as illustrated in the accompanying drawings. The accompanying drawings, which are incorporated herein and form a part of the specification, further serve to explain the principles of the present disclosure and to enable a person skilled in the pertinent art to make and use the embodiments of the present disclosure. The drawings may not be to scale.

FIG. 1A shows a perspective side view of a load support unit according to embodiments herein.

FIG. 1B shows a side view of a load support unit of according to embodiments herein.

FIG. 1C shows an expanded view of a load support unit according to embodiments herein.

FIG. 2 shows a holder post of the load support unit according to embodiments herein.

FIG. 3A shows a side view of a base adapter of the load support unit according to embodiments herein.

FIG. 3B shows a top view of the base adapter of a holder post of the load support unit according to embodiments herein.

FIG. 4A shows a holder post within a base adapter of the load support unit according to embodiments herein.

FIG. 4B shows a cross-section of a holder post and a base adapter according to embodiments herein.

FIG. 5A shows a perspective side view of a swivel joint and a knuckle joint of the load support unit according to embodiments herein.

FIG. 5B shows an expanded view of a swivel joint and a knuckle joint according to embodiments herein.

FIG. 5C shows a cross section of a swivel joint and a knuckle joint of according to embodiments herein.

FIGS. 6A-6B show expanded views of a knuckle joint of a load support unit according to embodiments herein.

FIGS. 6C-6D show cross-sections of a knuckle joint according to embodiments herein.

FIG. 6E shows a cross-section of a knuckle joint in an unlocked configuration according to embodiments herein.

FIG. 6F shows a perspective side view of actuator pawls and spring element of the knuckle joint according to embodiments herein.

FIG. 6G shows a cross-section of a knuckle joint in a locked configuration according to embodiments herein.

FIG. 6H shows a side view of actuator pawls and spring elements disposed within a body of the knuckle joint according to embodiments herein.

FIGS. 7A-7B show expanded views of a rotational joint of the load support unit according to embodiments herein.

FIG. 7C shows a second end of an upper arm and a rotator ball of the load support unit according to embodiments herein.

FIG. 7D shows a socket of a rotational joint according to embodiments herein.

FIG. 7E shows a socket disposed around a rotator ball of a rotational joint according to embodiments herein.

FIG. 7F shows a cross-section of a rotational joint according to embodiments herein.

FIG. 8A shows a front side of a back portion of a load attachment device of a load support unit according to embodiments herein.

FIG. 8B shows a back side of a front portion of the load attachment device according to embodiments herein.

FIG. 8C shows an expanded view of the load attachment device according to embodiments herein.

FIG. 8D shows a side view of the load attachment device according to embodiments herein.

FIG. 8E shows a perspective view of a load coupled to the load attachment device according to embodiments herein.

FIGS. 9A-9C illustrate load support units having different dimensions consistent with embodiments hereof.

FIG. 10 shows a perspective view of the load support unit coupled to a cart according to embodiments herein.

### DETAILED DESCRIPTION

It should be understood that various embodiments disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single device or component for purposes of clarity, it should be understood that the techniques of this disclosure may be performed by a combination of devices or components associated with, for example, a delivery device. The following detailed description is merely exemplary in nature and is not intended to limit the invention of the application and uses of the invention. Furthermore, there is no intention to be bound by any expressed or implied theory presented in the preceding field of the invention, background, summary or the following detailed description.

As used in this specification, the singular forms “a,” “an,” and “the” specifically also encompass the plural forms of the terms to which they refer, unless the content clearly dictates otherwise. The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 20%. It should be understood that use of the term “about” also includes the specifically recited number of value.

As used herein, the term “generally” and “substantially” mean approximately. When used to describe angles such as “substantially parallel” or “substantially perpendicular” the term “substantially” means within 10 degrees of the angle. When used to describe shapes such as “substantially” or “generally” cylindrical or “substantially” or “generally” tube-shaped or “generally” or “substantially” conical, the terms mean that the shape would appear cylindrical or tube-shaped or conical to a person of ordinary skill in the art viewing the shape with a naked eye.

Although the disclosure provides specific sizes for various parts, these are by way of example only. The specific sizes disclosed represent sizes or dimensions suitable for a specific example and are not intended to limit the disclosure in any way. It will be understood that larger or smaller components may be employed without departing from the functionality of these components.

The disclosure and figures describe embodiments and usage of the invention with respect to a specific orientation for illustrative purposes only. It is understood that this is by way of example only. Thus, as used herein, the terms “upwards”, “downwards”, “vertical”, “vertically”, “vertically upwards”, “vertically downwards”, “horizontal”, “left,” “right,” “proximal,” “distal,” “above,” “below,” “top,” “bottom,” and all other directional or orientational terms are relative only. The various embodiments and operations described herein may be used and oriented differently than described herein without departing from the scope of this disclosure.

Embodiments hereof relate to a load support unit having a lower arm, an upper arm, a mounting swivel, a swivel joint, a knuckle joint and a rotational joint. The load support unit may be configured for use with a cart, desk, or other platform and/or surface and may be configured to hold or support various loads, such as, for example, a tablet or other computing device. Other examples of loads are described throughout. More particularly, the load support unit may be configured to hold the tablet (or other load) and allow a user to adjust the orientation of the tablet as necessary. In the cart example above, the mounting swivel allows the load support unit to rotate relative to the cart, the swivel joint allows the upper arm to rotate relative to the lower arm, the knuckle joint allows the upper arm to pivot rotationally (e.g., upwards and downwards in the orientation illustrated) relative to the lower arm, and the rotational joint allows the load to rotate about the end of the upper arm, thereby allowing a user to adjust the tablet to a desired height, angle, direction, and orientation. Each of these joints are configured such that the load support unit maintains a configuration that a user places it in. That is, the load support unit is configured to permit a user to position and orient a load, such as a tablet, notebook, book, or other device and/or object, and to maintain the position and orientation.

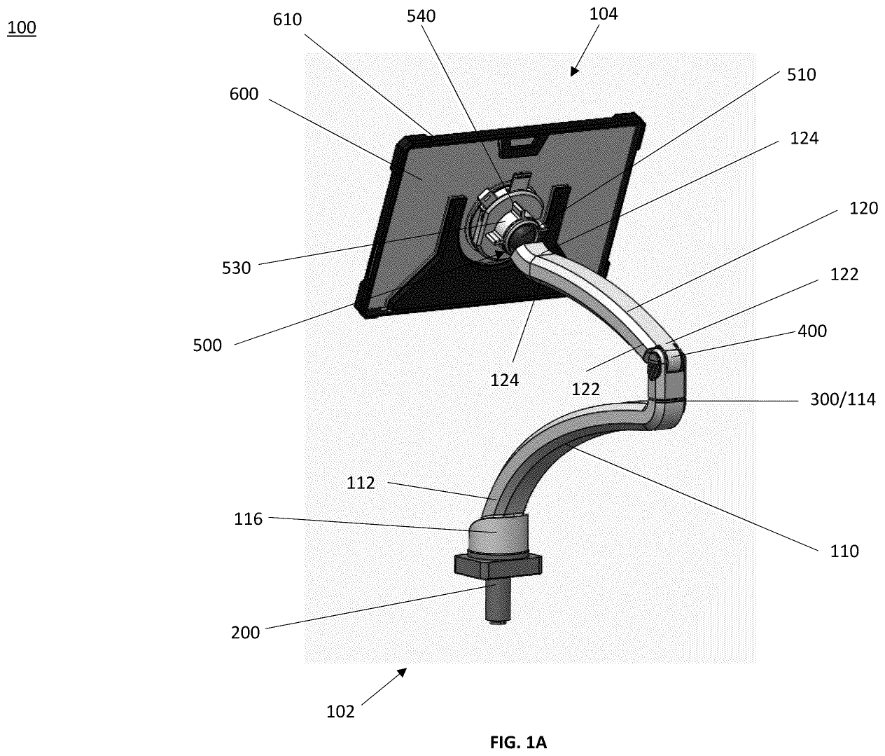

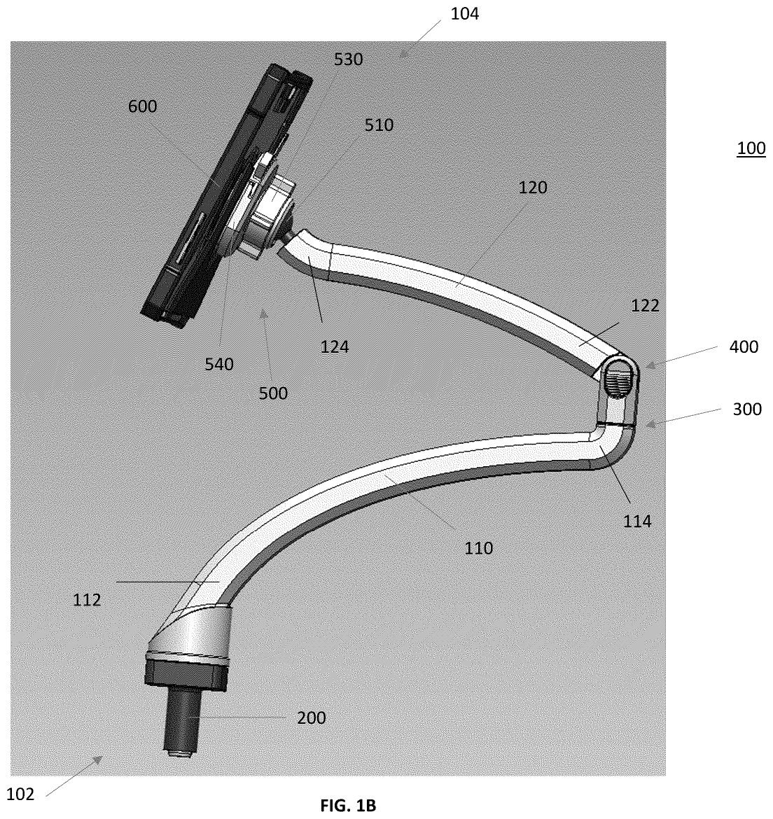

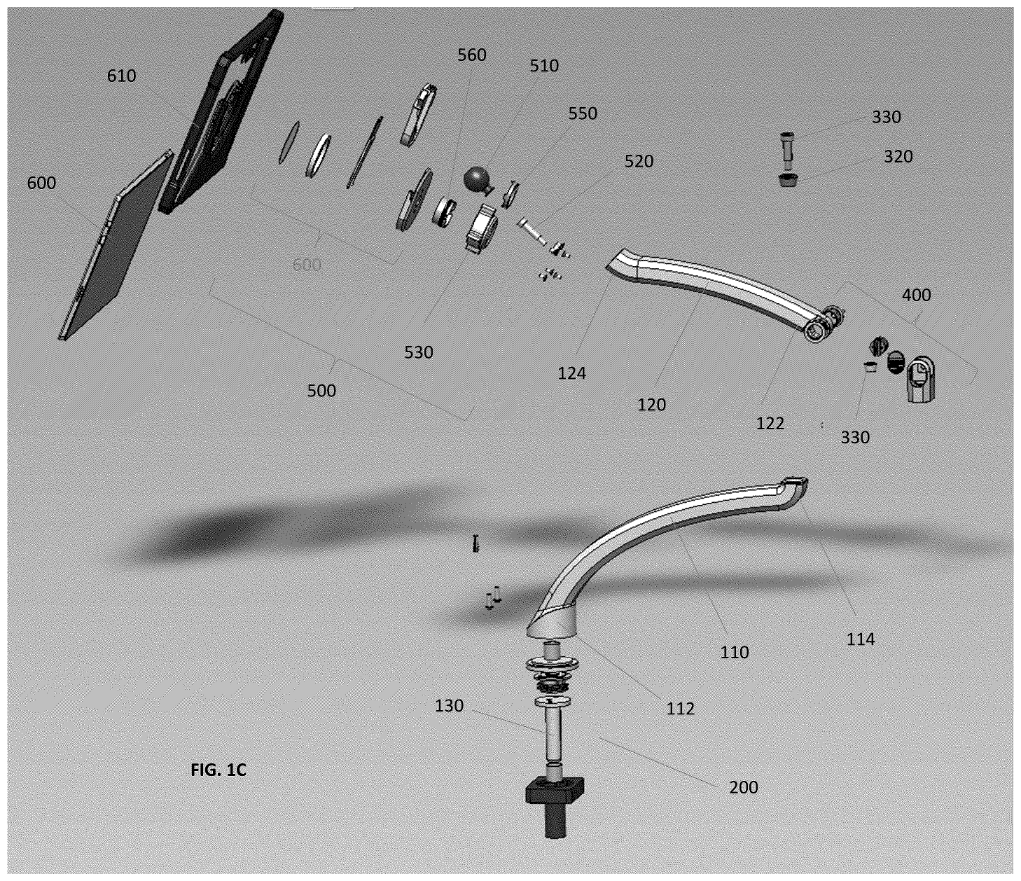

FIGS. 1A and 1B illustrate a load support unit 100 according to embodiments herein. The load support unit 100 includes a bottom end 102 and a top end 104. The top end 104 of the load support unit 100 is disposed vertically above the bottom end 102 of the load support unit 100 when the load support unit 100 is in use. In this and further embodiments, the top end 104 may be displaced horizontally and/or both vertically and horizontally from the bottom end 102, depending on an orientation of the load support unit 100. The load support unit 100 further includes a lower arm 110 (also referred to as a first arm) and an upper arm 120 (also referred to as a second arm). The lower arm 110 includes a base end 112 (also referred to as a first end) and a top end 114 (also referred to as a second end), and the upper arm 120 includes a bottom end 122 (also referred to as a first end) and a load end 124 (also referred to as a second end). The top end 114 of the lower arm 110 is coupled to the bottom end 122 of the upper arm 120 and extends therefrom. In general, the base end 112 of the lower arm 110 is disposed at the bottom end 102 of the load support unit 100 and the load end 124 of the upper arm 120 is disposed at the top end 104 of the load support unit 100, as shown in FIGS. 1A-1B.

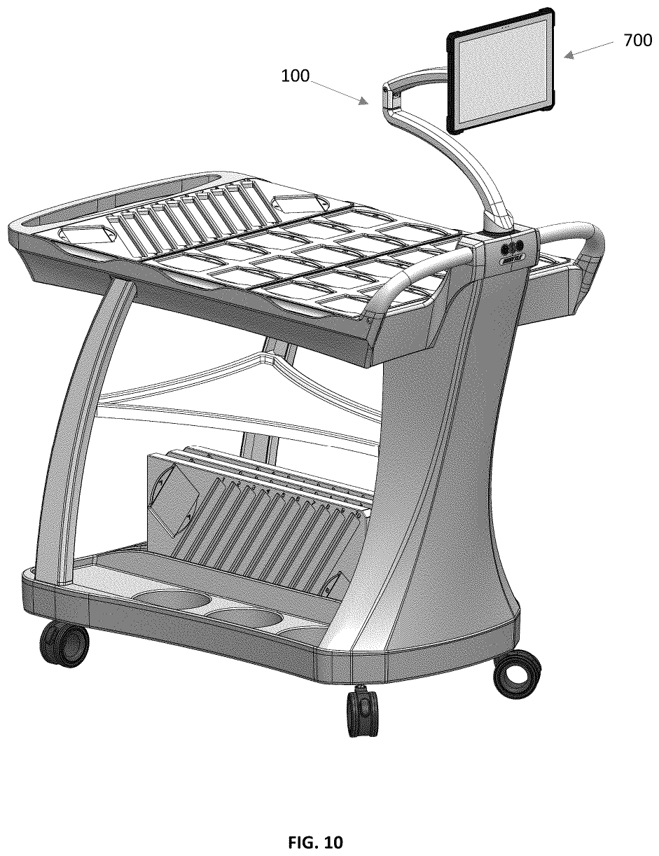

FIG. 1B shows a side view of the load support unit 100 according to embodiments herein. The lower arm 110 of the load support unit 100 may be substantially curved so as to describe an arcing shape. In further embodiments, the lower arm 110 may be substantially straight and/or may describe different curved shapes. A cross-section of the lower arm 110 may be rectangular-shaped, rectangular prism-shaped, rectangular cuboid-shaped, rectangular parallelepiped-shaped, circular, oval, hexagonal, octagonal, or any other appropriate shape. The upper arm 120 of the load support unit 100 may be substantially straight arm segment and/or may be curved. The load support unit 100 further includes a mounting swivel 200, a swivel joint 300, a knuckle joint 400 and a rotational joint 500, as shown in the expanded view of the load support unit 100 in FIG. 1C. The mounting swivel 200 is disposed at the bottom end 102 of the load support unit 100, coupled to the base end 112 of the lower arm 110 and is configured to adapt the load support unit 100 to a cart, desk, or other surface, as shown in FIG. 10. The mounting swivel 200 allows the load support unit 100 to rotate 360 degrees relative to the cart, desk, or other surface, described in further detail below. The swivel joint 300 is disposed between the lower arm 110 and the upper arm 120 of the load support unit 100 and is configured to allow the upper arm 120 to rotate 360 degrees relative to the lower arm 110 of the load support unit 100, described in further detail below. The knuckle joint 400 is disposed between the lower arm 110 and the upper arm 120 of the load support unit 100 and, in some embodiments, vertically above the swivel joint 300, as shown in FIG. 1B. The knuckle joint 400 is configured to allow the upper arm 120 to pivot in a rotational motion relative to the lower arm 110 of the load support unit 100. The knuckle joint 400 also allows a user to lock the upper arm 120 in the chosen orientation, described in further detail below. The rotational joint 500 is disposed at the load end 124 of the upper arm 120 and couples a load 700 to the load support unit 100 via a load attachment device 600. The rotational joint 500 is also configured to allow a user to rotate the load 700 about the load end 124 of the upper arm 120 via a rotator ball 510 and a collar 530, described in further detail below.

In the embodiment shown and described herein, the load support unit 100 is mounted to a surface in an orthogonal orientation, i.e., the load support unit 100 extends substantially vertically and substantially perpendicularly from a flat surface. Thus, the directional terms used herein describe that relationship. However, as discussed above the load support unit 100 may be mounted in other orientations and positions. For example, the load support unit 100 may be mounted to a vertically extending surface and may extend orthogonally from that surface, i.e., the load support unit 100 may extend perpendicularly from a vertically extending wall. In other embodiments, the load support unit 100 may extend diagonally from a vertical or horizontal surface, or from a diagonally oriented surface, etc. Thus, the directional terms used herein are for illustrative purposes based on the orientation of the load support unit 100 relative to the surface it is mounted to. In other embodiments requiring different orientations, relative directions and orientations between components of the load support unit 100 would vary.

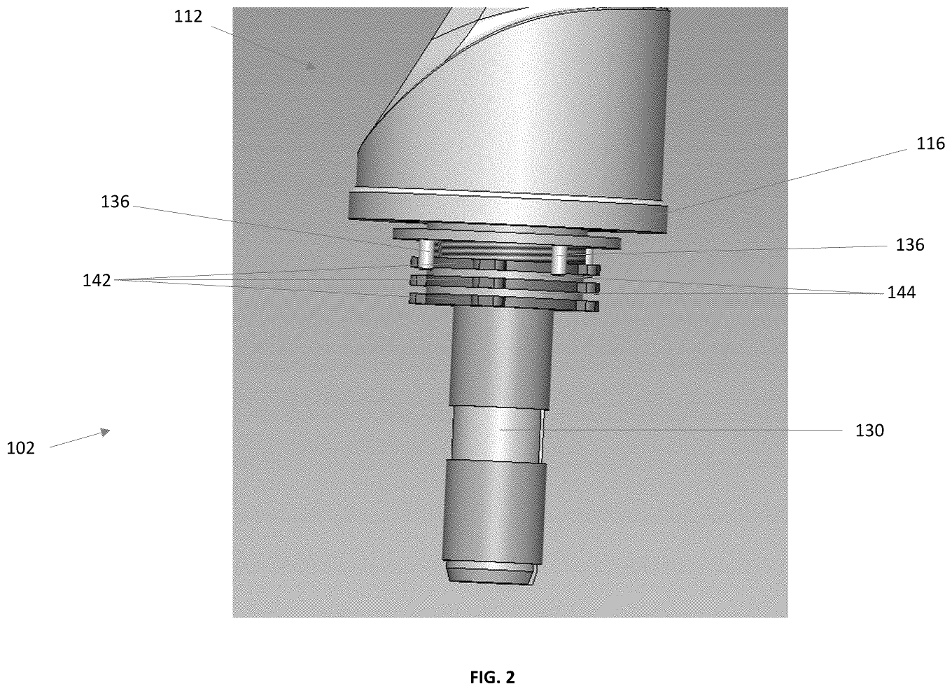

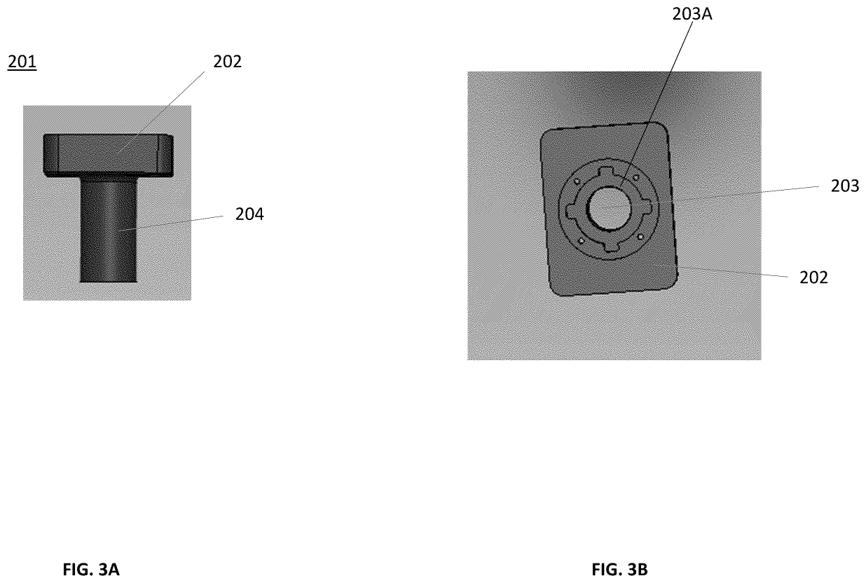

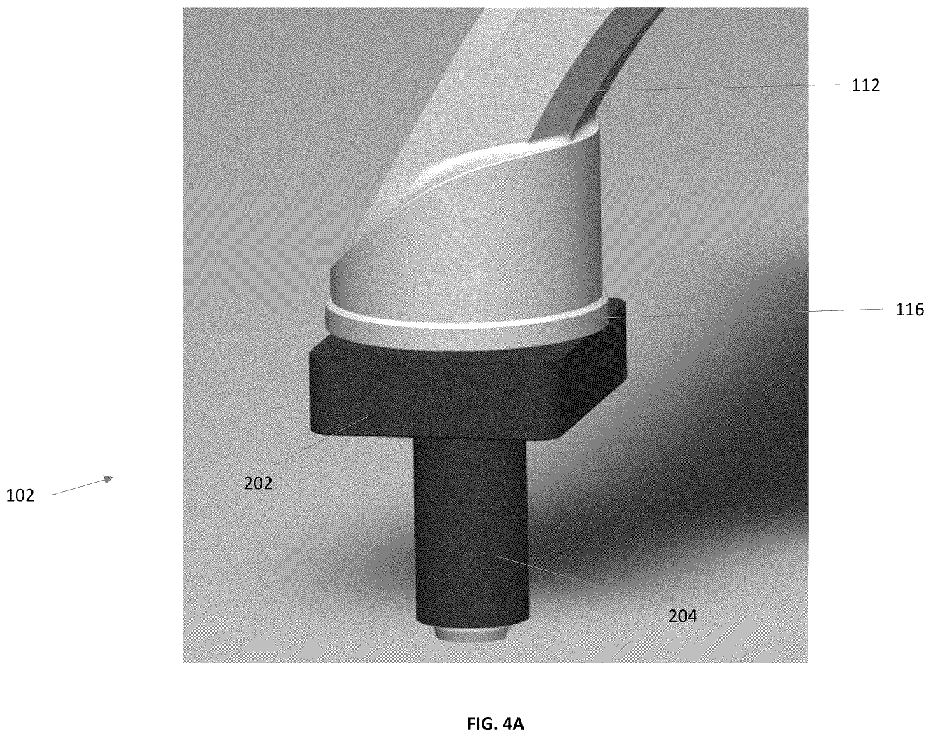

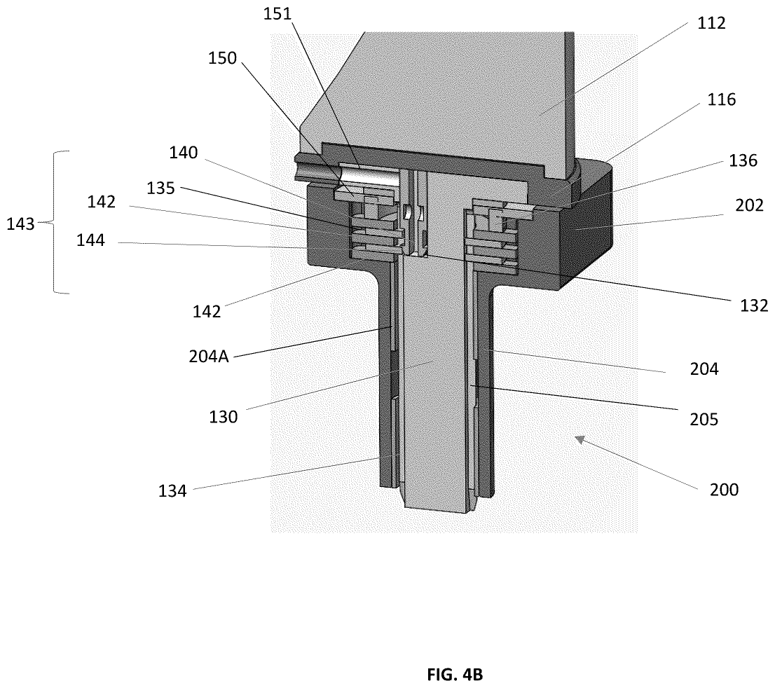

FIGS. 2-4B illustrate a mounting swivel 200 consistent with embodiments hereof. Broadly, the mounting swivel 200 includes a holder post 130 coupled to a base plate 116 disposed at the base end 112 of the lower arm 110, a base block 202 and base socket 204, and an array of componentry described in greater detail below. FIG. 2 illustrates the holder post 130 and some of the components of the mounting swivel 200. FIGS. 3A, 3B, and 4A illustrate the base block 202 and base socket 204. FIG. 4B illustrates the mounting swivel 200 assembly.

FIG. 2 shows a close-up view of the bottom end 102 of the load support unit 100 according to embodiments herein. The base end 112 of the lower arm 110 includes a base plate 116 disposed at a bottom of the base end 112. The bottom end 102 of the load support unit 100 further includes a holder post 130 that forms a portion of the mounting swivel 200. The holder post 130 is a substantially cylindrical-shaped segment that is coupled to a center of the base plate 116 of the lower arm 110 and extends vertically downwards therefrom, although angled orientations may also be appropriate in this and other embodiments. The mounting swivel 200 further includes a pocket 132 (shown in FIG. 4B), one or more keyways 134 (shown in FIG. 4B), spring elements 136, a latch 140 (shown in FIG. 4B), clutch plates 142, and friction plates 144.

FIGS. 3A-3B show a side view and a top view of a base adapter 201, respectively, according to embodiments herein. The base adapter 201 includes a base block 202 (which may be any suitable shape) and a substantially cylindrical-shaped base socket 204 coupled to a bottom side of the base block 202 and extending longitudinally therefrom. The base block 202 may have a height of about 18 mm (i.e., in a range from 15-21 mm), a length of about 58 mm (i.e., in a range from 47-69 mm), and a width of about 75 mm (i.e., in a range from 60-90 mm). The base socket 204 may have a length of about 48 mm (i.e., in a range from 38-58 mm) and a width or diameter of about 25 mm (i.e., in a range from 20-30 mm). The base block 202 further includes a cylindrical opening 203 that extends through the entire base block 202, from a top side to a bottom side of the base block 202. The cylindrical opening 203 of the base block 202 has a first diameter of about 18 mm (i.e., in a range from 15-21 mm). The cylindrical opening 203 of the base block 202 is defined by a circumferential wall 203A, as shown, for example, in FIG. 3B. The base socket 204 also includes a cylindrical opening 205 that extends through the entire longitudinal length of the base socket 204, from a first end to a second end of the base socket 204. The cylindrical opening 205 has a diameter smaller than that of the cylindrical opening 203. The cylindrical opening 205 of the base socket 204 is defined by a circumferential wall 204A, as shown, for example, in FIG. 4B. The cylindrical opening 203 of the base block 202 and the cylindrical opening 205 of the base socket 204 are connected such that an opening extends through an entire longitudinal length of the base adapter 201, as shown, for example, in FIG. 4B. The base adapter 201 may include aluminum, plastic and/or any other materials known to those skilled in the art.

Referring now to FIG. 4B, the cylindrical openings 203, 205 of the mounting swivel 200 are sized and shaped to house the holder post 130, spring elements 136, clutch plates 142 and friction plates 144. The clutch plates 142 and the friction plates 144 form a friction stack 143. The friction plates 144 are disposed between the clutch plates 142. The entire friction stack 143 is biased together by the spring elements 136, which apply a biasing force to the friction stack 143 (as shown, the biasing force is applied downwards, but it may applied in other directions when the mounting swivel 200 is mounted in a different orientation). The friction stack 143 is held in place by the securement ring 150, which is disposed (e.g., via press fitting, screw attachment, or other suitable securable feature) within the opening 203 of the base block 202. The securement ring 150 also provides a surface for the spring elements 136 to press against. The clutch plates 142 are generally ring shaped, permitting the holder post 130 to pass through their centers, and include extending keys that extend from their outer circumference to engage a keyway (or keyways) 135 disposed within the base block 202. Thus, the clutch plates 142 are rotationally locked to the base block 202. The friction plates 144 are generally ring shaped, permitting the holder post 130 to pass through their centers, and include extending keys that extend from their inner circumference to engage the keyway (or keyways) 134 disposed along a length of the holder post 130. Thus, the friction plates 144 are rotationally locked to the holder post 130. When the holder post 130 is rotated therefore, friction between the friction plates 144 and the clutch plates 142 provides a responsive force. The friction between the friction plates 144 and the clutch plates 142 serves to prevent or reduce accidental or non-deliberate rotation in response to incidental forces provided during manipulation of other joints of the load support unit 100 and further serves to provide an appropriate feeling of weight or resistance to a user manipulating the arm. The strength of the friction may be controlled by selecting a stiffer spring element 136 or changing the number of friction plate 144 and clutch plates 142. For example, the number of friction plates 144 and/or clutch plates 142 may be exactly one, two, three, four, five, or more.

The mounting swivel 200 also may include a locking feature. The holder post 130, which extends from the base plate 116 of the lower arm 110, may include a latch 140 disposed within a pocket 132 thereof. The latch 140 is spring loaded with a catch configured to engage one or more of the clutch plates 142. The spring loading of the latch 140 may be achieved by any suitable spring element and may bias the latch 140 towards engagement with the clutch plates 142. The latch 140 may be accessed via a tunnelway 151 extending through the base block 202 from an exterior to the interior. A tool, such as a rod, may be inserted into the tunnelway 151 to contact the latch 140 and press it away from the clutch plates 142, thereby releasing the lock and permitting the holder post 130 to be removed from the base adapter 201.

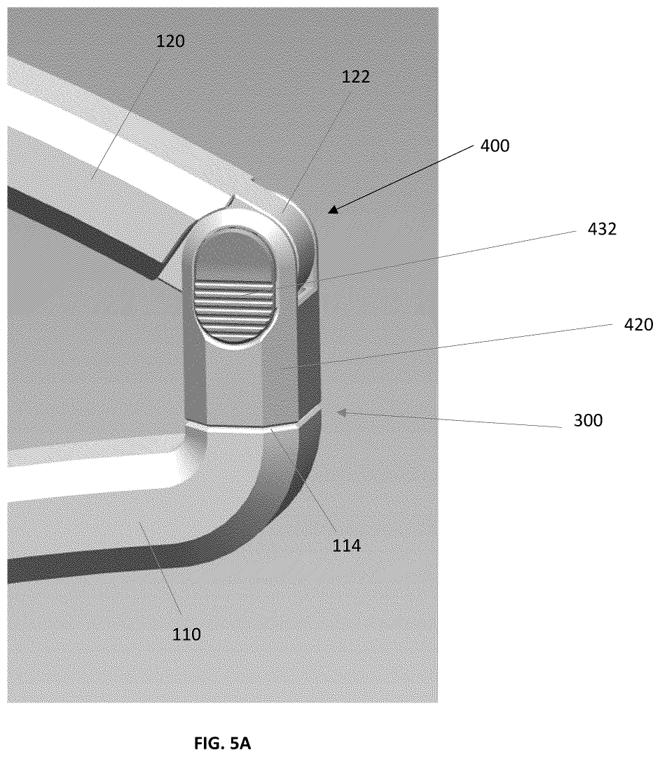

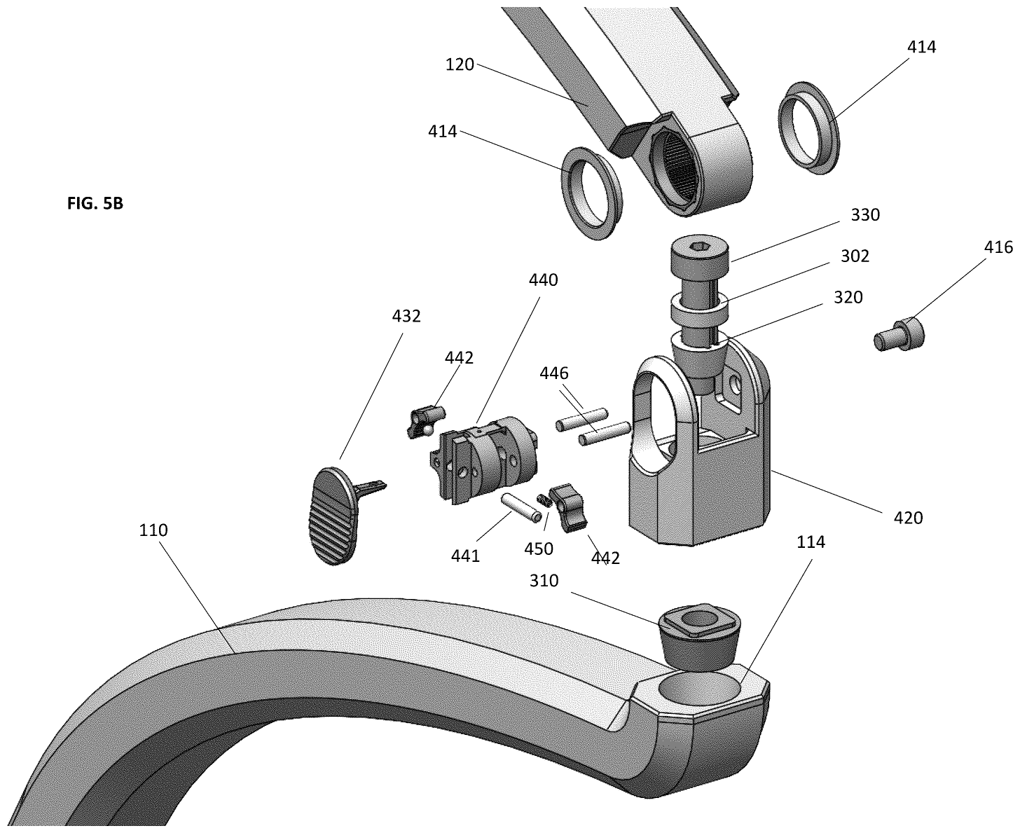

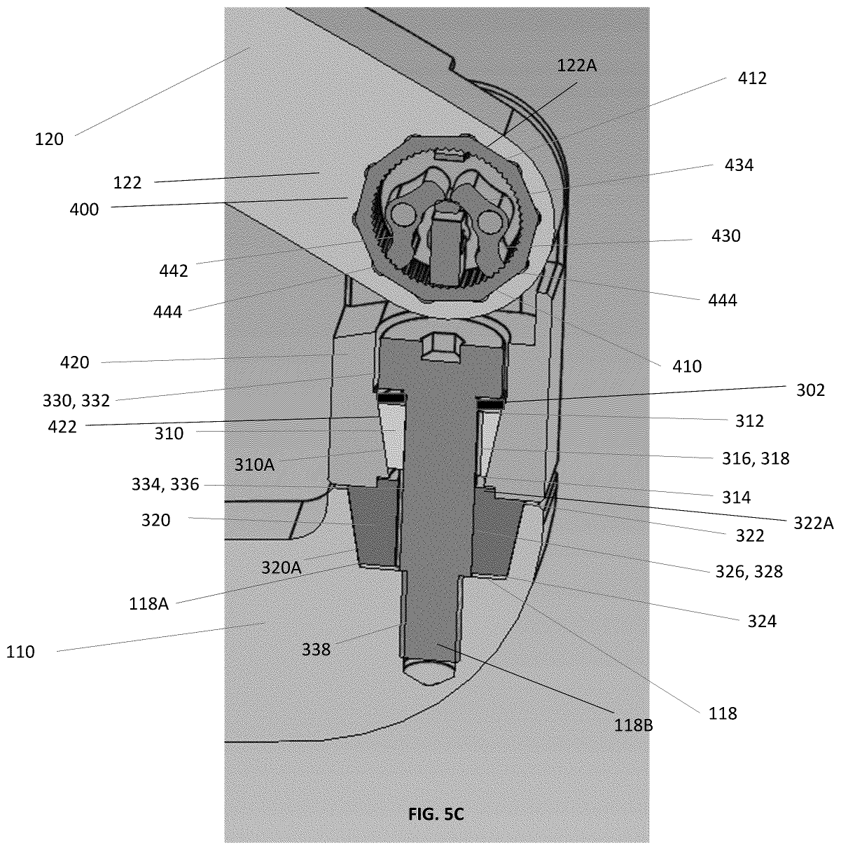

FIG. 5A provides a close-up view of the swivel joint 300 and the knuckle joint 400 of the load support unit 100 according to embodiments herein. The top end 114 of the lower arm 110 is disposed adjacent to the bottom end 122 of the upper arm 120 of the load support unit 100. In this and further embodiments, the top end 114 of the lower arm 110 may be disposed vertically below the bottom end 122 of the upper arm 120 or may be disposed in other orientations. More specifically, the top end 114 of the lower arm 110 is disposed directly below the bottom end 122 of the upper arm 120 of the load support unit 100. An outer shell 420, that houses the knuckle joint 400 and the swivel joint 300, is disposed between the top end 114 of the lower arm 110 and the bottom end 122 of the upper arm 120, as shown in FIG. 5A.

FIG. 5B shows an expanded view of the swivel joint 300 and the knuckle joint 400 of the load support unit 100. The relative orientations of the parts of the swivel joint 300 and the knuckle joint 400 shown in FIG. 5B is consistent with embodiments hereof. The relative positioning of the parts of the swivel joint 300 and the knuckle joint 400 shown in FIG. 5B is provided to individually illustrate the parts and is not necessarily indicative of assembled positioning. FIG. 5C provides a cut-away view of the swivel joint 300 and the knuckle joint 400. The swivel joint 300 includes a first tapered bushing 310, a second tapered bushing 320, a shoulder screw 330 and a wave spring 302. The first tapered bushing 310 is a tapered cylinder (or truncated cone) that includes an outer surface 310A, a wide end 312, a narrow end 314 and a central lumen 316 defined by an inner circumferential wall 318 and extending from the wide end 312 to the narrow end 314. The central lumen 316 of the first tapered bushing 310 has a substantially circular cross-section sized and shaped to receive the shoulder screw 330 therewithin, described in further detail below. The outer surface 310A of the first tapered bushing 310 tapers such that a diameter of the wide end 312 of the first tapered bushing 310 is larger than a diameter of the narrow end 314 of the first tapered bushing 310, as shown in FIG. 5C. The first tapered bushing 310 may have a length of about 9 mm (i.e., in a range from 7-11 mm). The wide end 312 of the first tapered bushing 310 may have an outer diameter of about 16 mm (i.e., in a range from 13-19 mm) while the narrow end 314 of the first tapered bushing 310 may have an outer diameter of about 13 mm (i.e., in a range from 10-16 mm). The central lumen 316 extends an entire length of the first tapered bushing 310, extending from the wide end 312 to the narrow end 314, and may have a diameter of about 10 mm (i.e., in a range from 8-12 mm). The first tapered bushing 310 may be formed from plastic, bronze, and/or any other materials known to those skilled in the art.

Similarly, the second tapered bushing 320 is a tapered cylinder (or truncated cone), or other frustoconical-shaped element that includes an outer surface 320A, a wide end 322, a narrow end 324 and a central lumen 326 defined by an inner circumferential wall 328 and extending from the wide end 322 to the narrow end 324. The central lumen 326 of the second tapered bushing 320 has a substantially circular cross-section sized and is shaped to receive the shoulder screw 330 therewithin, described in further detail below. The outer surface 320A of the second tapered bushing 320 tapers such that a diameter of the wide end 322 of the second tapered bushing 320 is larger than a diameter of the narrow end 324 of the second tapered bushing 320, as shown in FIG. 5C. The wide end 322 of the second tapered bushing 320 further includes a lip or shoulder 322A that protrudes about 1 mm (i.e., in a range from 0.8-1.2 mm) from the wide end 322 of the second tapered bushing 320. The shoulder 322A extends circumferentially around the central lumen 326 of the second tapered bushing 320, as shown in FIG. 5C. The shoulder 322A that protrudes outwardly from the wide end 322 of the second tapered bushing 320 is configured to fit within a cavity of the outer shell 420 of the load support unit 100, described in further detail below with respect to FIG. 5C. The second tapered bushing 320 may have a length of about 10 mm (i.e., in a range from 8-12 mm). The wide end 322 of the second tapered bushing 320 may have an outer diameter of about 23 mm (i.e., in a range from 19-27 mm) while the narrow end 324 of the second tapered bushing 320 may have an outer diameter of about 19 mm (i.e., in a range from 15-23 mm). The central lumen 326 extends an entire length of the second tapered bushing 320, extending from the wide end 322 to the narrow end 324, and may have a diameter of about 10 mm (i.e., in a range from 8-12 mm). The second tapered bushing 320 comprises plastic, bronze, and/or any other materials known to those skilled in the art.

The shoulder screw 330 of the swivel joint 300 includes a head 332 and a body 334 that extends longitudinally outward from the head 332. The head 332 of the shoulder screw 330 is substantially cylindrical-shaped with a length of about 7 mm (i.e., in a range from 5-9 mm) and a diameter of about 16 mm (i.e., in a range from 13-19 mm). The body 334 of the shoulder screw 330 is a substantially cylindrical-shaped member that further includes a proximal portion 336 and a distal portion 338. The proximal portion 336 of the body 334 is coupled to a bottom end of the head 332 of the shoulder screw 330 and extends longitudinally therefrom. The proximal portion 336 of the body 334, which may have a smooth outer surface, may have a length of about 25 mm (i.e., in a range from 20-30 mm) and a diameter of about 10 mm (i.e., in a range from 8-12 mm). The distal portion 338, which is threaded, of the body 334 extends longitudinally from a bottom end of the proximal portion 336 of the body 334 and may have a length of about 12 mm (i.e., in a range from 10-14 mm) and a diameter of about 8 mm (i.e., in a range from 6-10 mm). Thus, the diameter of the proximal portion 336 may be larger than the diameter of the distal portion 338. The proximal portion 336 of the body 334 of the shoulder screw 330 is sized and shaped to fit within the central lumen 316 of the first tapered bushing 310 and the central lumen 326 of the second tapered bushing 320, as shown, for example, in FIG. 5C.

The top end 114 of the lower arm 110 of the load support unit 100 may face approximately vertically upwards, as shown in FIG. 5B, although angled orientations may be used as well. The top end 114 of the lower arm 110 further includes a cavity 118 disposed therein, as shown, for example, in FIGS. 5B-5C. The cavity 118 at the top end 114 of the lower arm 110 includes a top portion 118A and a bottom portion 118B and is defined by a circumferential inner wall disposed within the top end 114 of the lower arm 110. The bottom portion 118B of the cavity 118 of the lower arm 110 is a hollow, cylindrical-shaped opening that is sized and shaped to receive the distal portion 338 of the shoulder screw 330, as shown in FIG. 5C. The bottom portion 118B of the cavity 118 is threaded to receive the threaded distal portion 338 of the shoulder screw 330. The top portion 118A of the cavity 118 of the lower arm 110 is a hollow conical opening that tapers in a longitudinal direction substantially parallel to an axis of the cavity 118 and is disposed directly above the bottom portion 118B of the cavity 118, as shown in FIG. 5C. The top portion 118A of the cavity 118 is sized and shaped to house or receive the second tapered bushing 320 of the swivel joint 300, as shown in FIG. 5C.

When assembled, the body 334 of the shoulder screw 330 is disposed within the central lumen 316 of the first tapered bushing 310 from the wide end 312 and extends therethrough until the wide end 312 of the first tapered bushing 310 is disposed directly below the bottom end of the head 332 of the shoulder screw 330, as shown in FIG. 5C. The inner circumferential wall 318 of the first tapered bushing 310 rests against the outer surface of the proximal portion 336 of the body 334 of the shoulder screw 330 (e.g., through a relatively tight coupling), and the outer surface 310A of the first tapered bushing 310 rests against a tapered inner lumen 422 of the outer shell 420 (e.g., though a relatively tight coupling), as shown in FIG. 5C.

The wave spring 302 is disposed in between the head 332 of the shoulder screw 330 and the wide end 312 of the first tapered bushing 310 and is configured to act as a biasing element that pushes the first tapered bushing 310 down within the tapered inner lumen 422 of the outer shell 420, as described in further detail below.

The body 334 of the shoulder screw 330 is further disposed within the central lumen 326 of the second tapered bushing 320 from the wide end 322 and extends therethrough until the narrow end 324 of the second tapered bushing 320 is aligned with the bottom end of the proximal portion 336 of the body 334 of the shoulder screw 330, as shown in FIG. 5C. The inner circumferential wall 328 of the second tapered bushing 320 rests against the proximal portion 336 of the body 334 of the shoulder screw 330 and the outer surface 320A of the second tapered bushing 320 rests against a tapered inner wall of the top portion 118A of the cavity 118 within the lower arm 110, as shown in FIG. 5C. The first tapered bushing 310 is disposed directly above the second tapered bushing 320 with the shoulder screw 330 extending through both central lumens 316, 326 of both tapered bushings 310, 320, respectively.

The assembly of the shoulder screw 330, first tapered bushing 310 and second tapered bushing 320 is disposed within the cavity 118 of the lower arm 110 of the load support unit 100 such that the distal portion 338 of the body 334 of the shoulder screw 330 is secured by the screw threads within the bottom portion 118B of the cavity 118 and the second tapered bushing 320 is disposed within the top portion 118A of the cavity 118 of the lower arm 110, as shown in FIG. 5C. The shoulder of the shoulder screw 330 (i.e., at the junction between the proximal portion 336 and the distal portion 338) abuts the bottom of the top portion 118A of the cavity 118, an arrangement that positively locates the shoulder screw 330 with respect to the lower arm 110. This positive location provides a consistent relative positioning between the shoulder screw 330 and the lower arm 110 during assembly, which serves to create a consistent distance between the bottom of the head 332 and the bottom surface of the top portion 118A of the cavity 118. This consistent distance during assembly ensures that the wave spring 302 is compressed appropriately to provide an appropriate amount of force on first tapered bushing 310.

The outer shell 420 of the load support unit 100 includes the tapered inner lumen 422 that is sized and shaped to house or enclose the first tapered bushing 310 and the head 332 of the shoulder screw 330. As such, the tapered inner lumen 422 of the outer shell 420 has a top portion sized and shaped to house the head 332 of the shoulder screw 330 and a bottom portion that tapers in a longitudinally direction substantially parallel to an axis of inner lumen 422 to effectively house the first tapered bushing 310, as shown in FIG. 5C. The shoulder 322A of the second tapered bushing 320 is sized and shaped to fit within a circumferential cavity disposed at a bottom end of the outer shell 420, as shown in FIG. 5C.

The shoulder screw 330 of the swivel joint 300 effectively couples the lower arm 110 and the second tapered bushing 320 to the outer shell 420 and the first tapered bushing 310. The outer shell 420 is further coupled to the knuckle joint 400 and the upper arm 120 of the load support unit 100, such that the lower arm 110 and the upper arm 120 of the load support unit 100 are effectively coupled via the shoulder screw 330 and the outer shell 420 that houses the swivel joint 300 and the knuckle joint 400 of the load support unit 100. The first tapered bushing 310 is rotationally keyed to the shoulder screw 330 to prevent relative rotation with the shoulder screw 330 and provide friction during relative rotation with the outer shell 420. The second tapered bushing 320 is rotationally keyed to the outer shell 420 to prevent relative rotation with the outer shell 420 and provide friction during relative rotation with the top portion 118A of the cavity 118. More specifically, the first tapered bushing 310 does not rotate relative to the shoulder screw 330 and the second tapered bushing 320 does not rotate relative to the outer shell 420. The first tapered bushing 310 and shoulder screw 330 of the swivel joint 300 remain stationary and the outer shell 420 and the second tapered bushing 320 are able to rotate in unison. As such, when the upper arm 120 is moved in any circumferential direction, the outer shell 420 and the second tapered bushing 320 rotate together about the shoulder screw 330 and the first tapered bushing 310 that remains stationary during rotational movement of the upper arm 120. This allows the upper arm 120 to rotate 360 degrees about the lower arm 110 of the load support unit 100 that remains stationary relative to the outer shell 420 and the upper arm 120 of the load support unit 100. The friction provided by first tapered bushing 310 and the second tapered bushing 320 provides a smooth resistance to rotation of the upper arm 120.

During the rotational movement of the outer shell 420 and the second tapered bushing 320, the tapered inner lumen 422 of the outer wall is in constant contact with the outer surface 310A of the first tapered bushing 310. Over time, the friction between the tapered inner lumen 422 of the outer shell 420 and the outer surface 310A of the first tapered bushing 310 may cause the first tapered bushing 310 to wear. As used herein, “wear” may refer to friction induced wear, a process by which material of a body may be lost, worn away, worn down, or removed due to friction. Friction induced wear of the first tapered bushing 310 leads to the loss of material from the first tapered bushing 310, resulting in a decrease in diameter. The wave spring 302 of the swivel joint 300, disposed directly above the first tapered bushing 310, biases the first tapered bushing 310 into the tapered interior lumen 422 of the outer shell 420 such that as the size of the first tapered bushing 310 decreases, it is pushed further into the tapered inner lumen 422. The first tapered bushing 310 is thus able to maintain surface contact between substantially all of the outer surface 310A (e.g., greater than 90%, greater than 95%, greater than 98%) and the tapered inner lumen 422 is maintained, even as size reductions of the tapered bushing 310 occur due to wear. Maintaining a high level of surface contact serves to maintain an appropriate level of friction when the upper arm 120 is rotated via the swivel joint 300. Because the first tapered bushing 310 will continue to be pushed down by the wave spring 302 into the tapered inner lumen 422 such that surface contact is maintained as the first tapered bushing 310 wears down from use over time, the loss of joint friction is reduced.

Similarly, the second tapered bushing 320 provides friction during rotation, as the outer surface 320A of the second tapered bushing 320 is in constant contact with the inner surface of the top portion 118A of the cavity 118 disposed within the top end 114 of the lower arm 110 as the second tapered bushing 320 rotates with the outer shell 420 and the upper arm 120 of the load support unit 100, as shown in FIG. 5C. The weight of the upper arm 120 and the knuckle joint 400, as well as the force provided by the shoulder screw 330 and wave spring 302 as transferred through the first tapered bushing 310, acts as a biasing element that transfers a biasing force on the second tapered bushing 320, pushing the second tapered bushing 320 further into the top portion 118A of the cavity 118 as the outer surface 320A of the second tapered bushing 320 is worn down from the rotational friction against the inner wall of the top portion 118A of the cavity 118. The second tapered bushing 320 is thus able to maintain surface contact between substantially all of the outer surface 320A (e.g., greater than 90%, greater than 95%, greater than 98%) and the inner wall of the top portion 118A of the cavity, even as size reductions of the tapered bushing 320 occur due to wear.

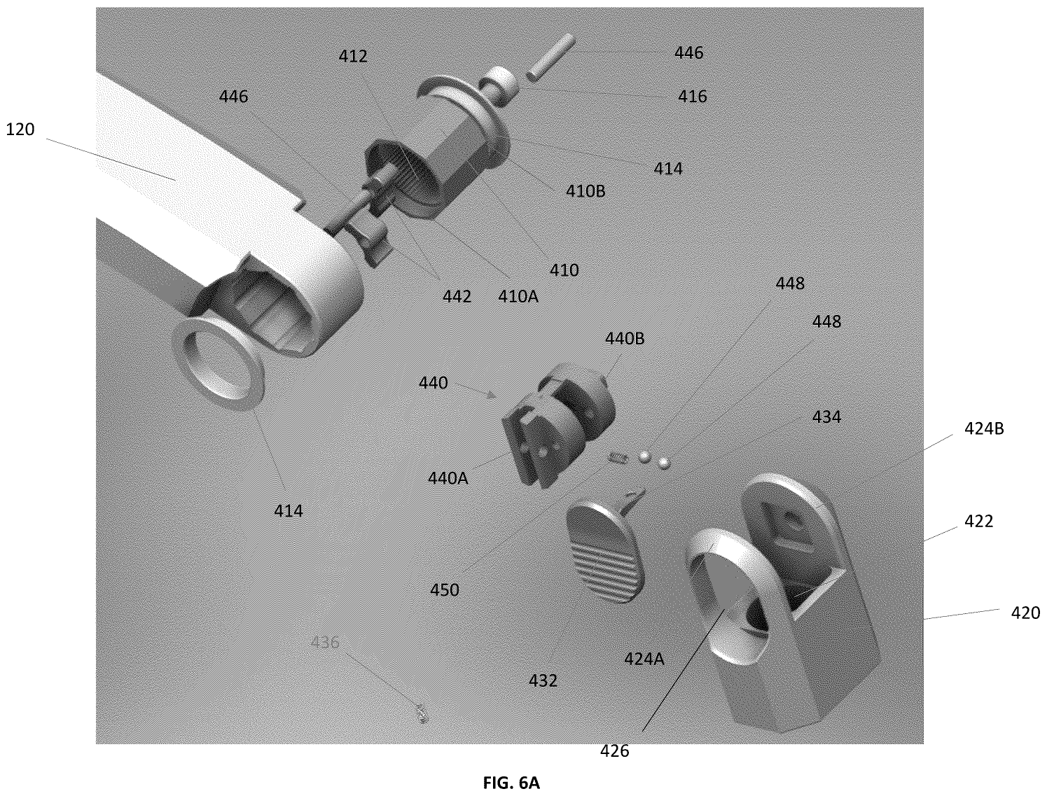

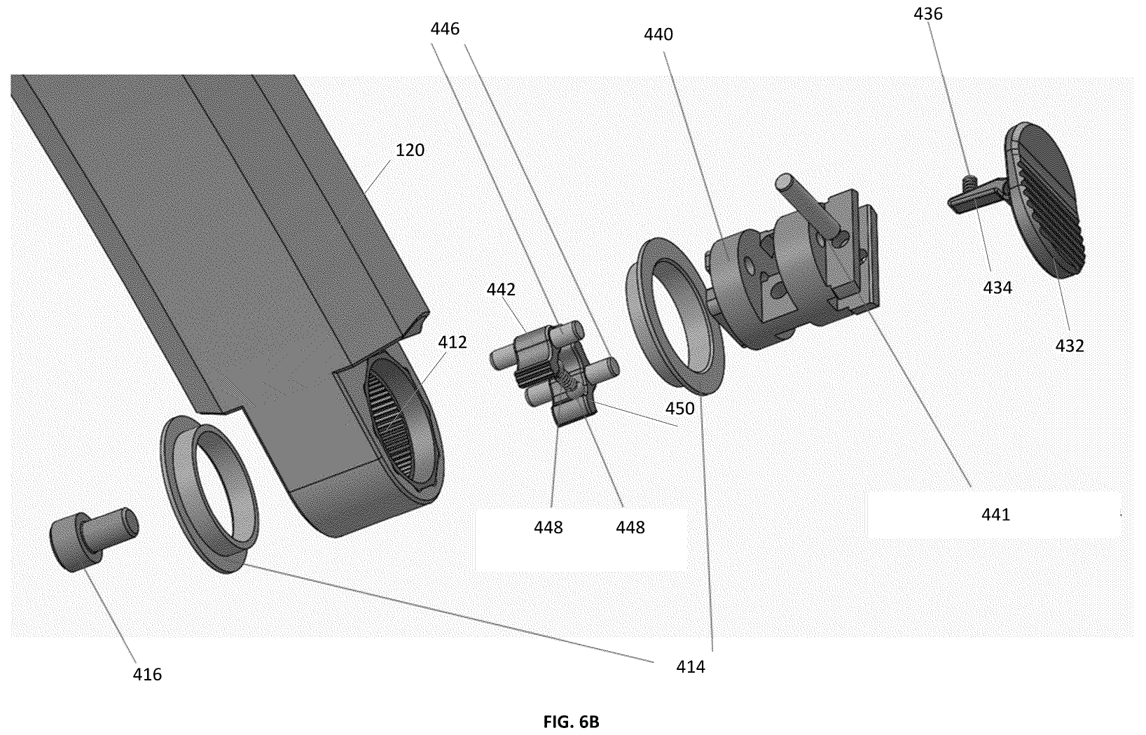

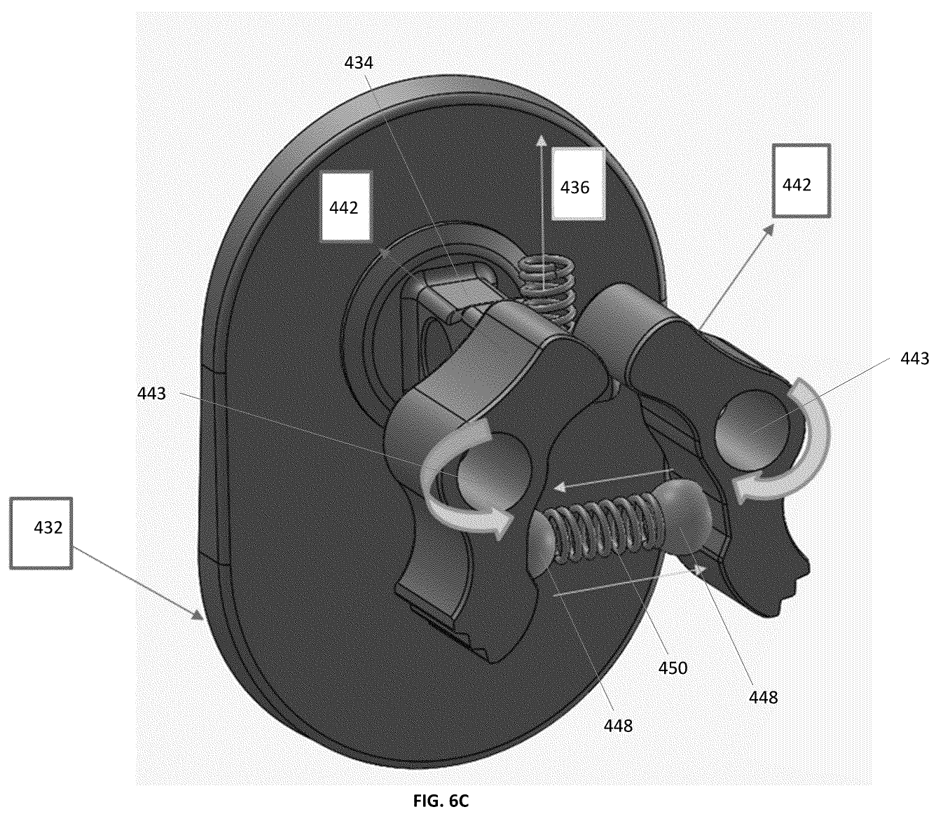

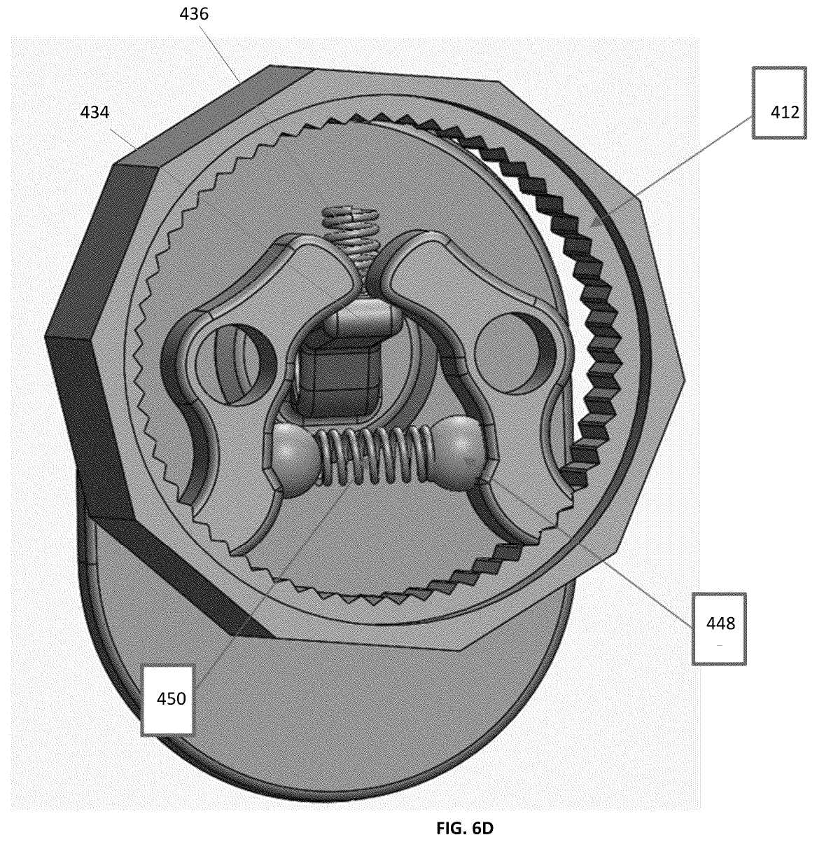

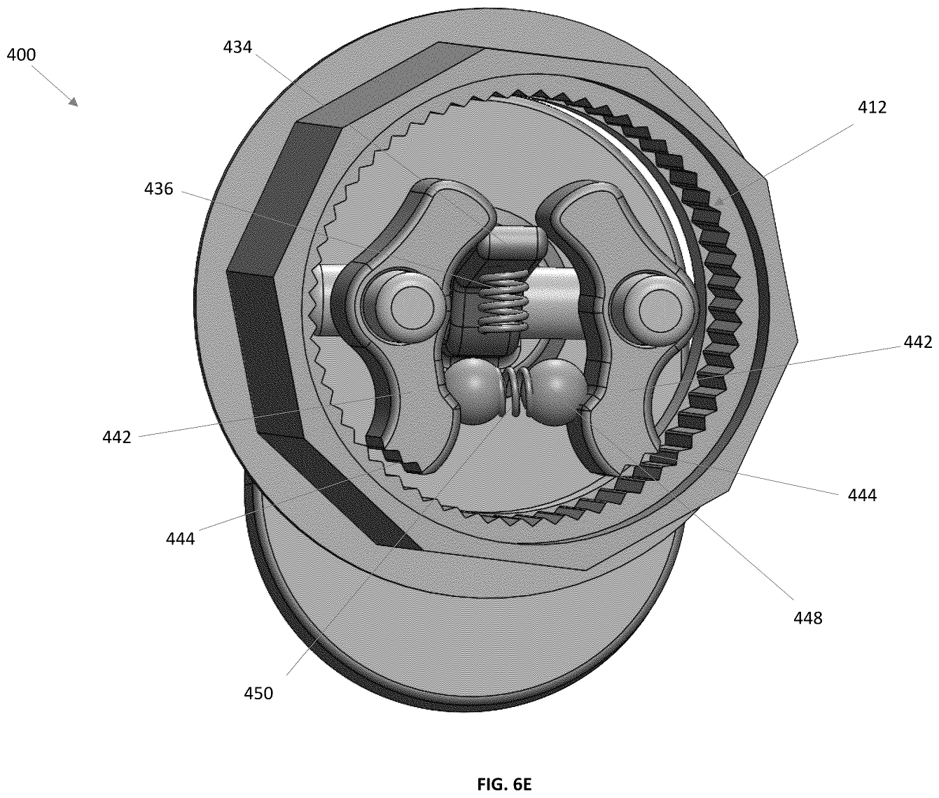

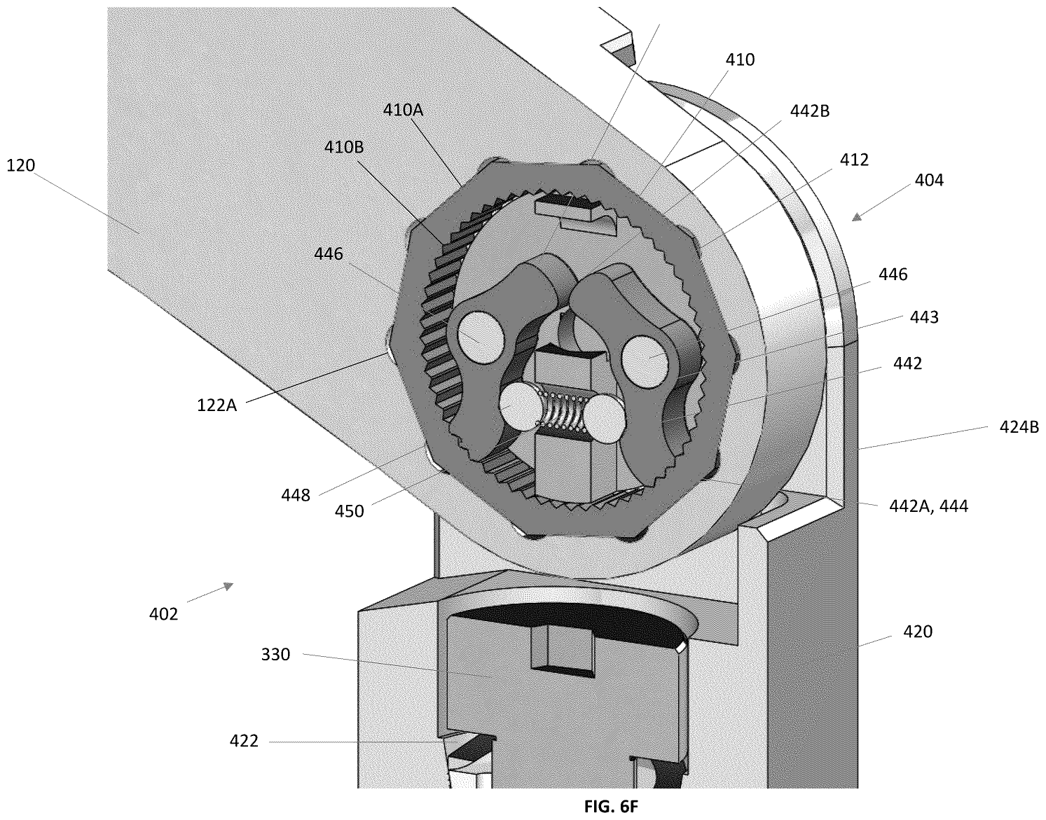

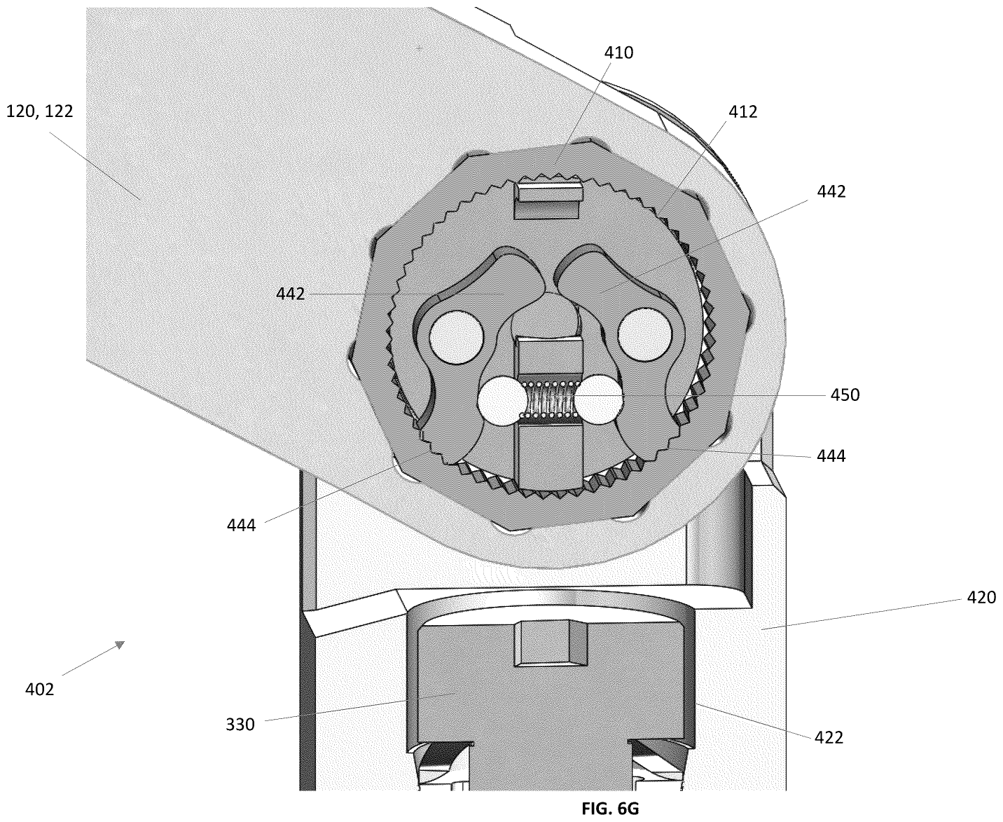

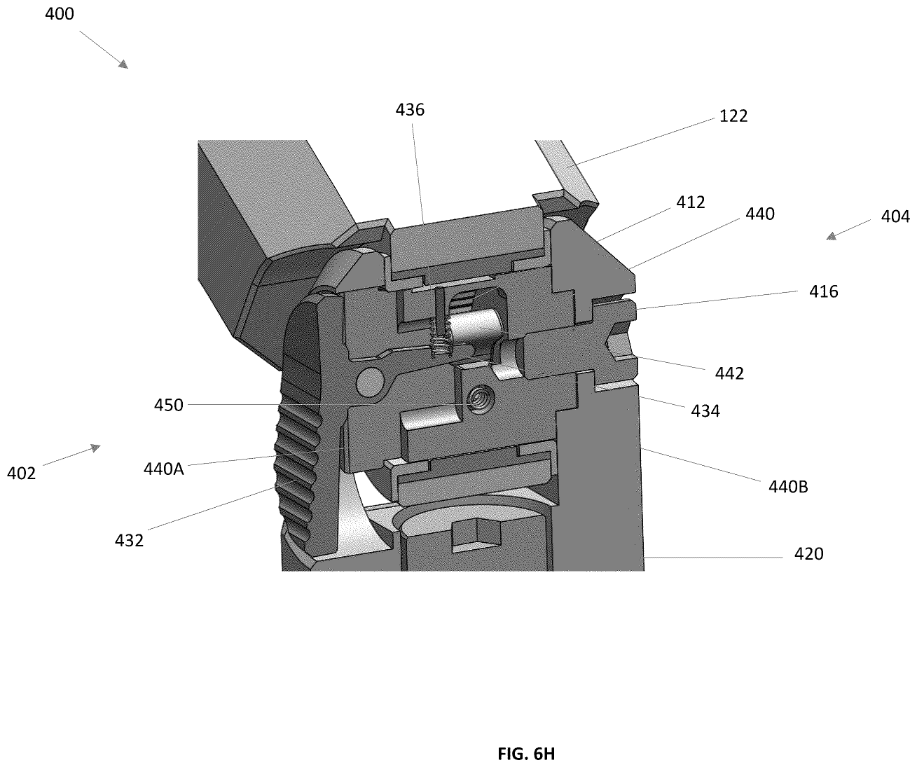

FIGS. 5B, 5C and 6A-6H illustrate the knuckle joint 400 consistent with embodiments hereof. FIGS. 6A and 6B are exploded views of the knuckle joint 400, and show the various elements of the knuckle joint 400. FIGS. 6C, 6D, and 6E illustrate operation of the knuckle joint 400. FIGS. 6F and 6G are plan cross-sectional views of the knuckle joint 400, illustrating various components. FIG. 6H is a side cross-sectional view of the knuckle joint 400, illustrating various components. The following discussion refers to the various illustrations of the knuckle joint 400.

As discussed above, the knuckle joint 400 of the load support unit 100 is disposed adjacent to the swivel joint 300 (in this and further embodiments, the load support unit 100 may be disposed vertically above the swivel joint 300). The knuckle joint 400 includes a body 410 and an actuator element 430. The bottom end 122 of the upper arm 120 of the load support unit 100 includes a circumferential opening 122A that is sized and shaped to house the body 410 of the knuckle joint 400. The body 410 of the knuckle joint 400 is a substantially hollow, cylinder-shaped structure that further includes a front end 410A, a back end 410B and circumferential teeth 412 on an inner surface of the body 410, as shown, for example, in FIGS. 6E and 6G.

The actuator element 430 of the knuckle joint 400 further includes a trigger button 432, an engagement arm 434, a biasing spring 436, a pawl retainer hub 440, at least one actuator pawl 442, at least one pawl pin 446, exactly two contact ball bearings 448 and a spring element 450, as shown in FIG. 6A. Most, if not all, elements of the knuckle joint 400 may be housed within the opening of the body 410 that is disposed within the opening 122A at the bottom end 122 of the upper arm 120. The outer shell 420 of the load support unit 100 includes two side walls 424A, 424B that extend from a lower portion of the outer shell 420 that includes the tapered inner lumen 422, as shown in FIG. 6A. A front side wall 424A of the outer shell 420 includes a substantially oval-shaped cutout or opening 426 that is sized and shaped to house the trigger button 432 of the knuckle joint 400. The front side wall 424A of the outer shell 420 allows the trigger button 432 to be exposed so a user may engage the trigger button 432, discussed below in greater detail. The side of the knuckle joint 400 with the exposed trigger button 432 is termed a front end 402 of the knuckle joint 400 for ease of description. A back side wall 424B extends substantially parallel to the front side wall 424A and includes a small opening sized and shaped to receive a mounting screw 416, as discussed in further detail below. The back side wall 424B of the outer shell 420 is configured to cover a back end 404 of the knuckle joint 400, as shown, for example, in FIG. 6F.

When assembled, the body 410 of the knuckle joint 400 is disposed within the opening 122A of the upper arm 120 such that the front end 410A of the body 410 is disposed at the front end 402 of the knuckle joint 400 and the back end 410B of the body 410 is disposed at the back end 404 of the knuckle joint 400, as shown in FIG. 6F. The pawl retainer hub 440 is disposed within the opening of the body 410. Two thrust washers 414 on either side of the body 410 and a mounting screw 416 disposed on the back end 404 of the knuckle joint 400 are used to secure the body 410 of the knuckle joint 400 within the opening 122A of the upper arm 120 and secure the pawl retainer hub 440 within the opening of the body 410, as shown in FIG. 6F. The pawl retainer hub 440 includes a first end 440A and a second end 440B. When the pawl retainer hub 440 is disposed within the body 410 of the knuckle joint 400, the first end 440A of the pawl retainer hub 440 aligns with the front end 410A of the body 410 and the second end 440B of the pawl retainer hub 440 aligns with the back end 410B of the body 410. The pawl retainer hub 440 further includes openings or holes that are sized and shaped to receive two pawl pins 446, described in further detail below.

The knuckle joint 400 includes at least one pawl 442 configured to engage with the circumferential teeth 412 of the body 410. The pawl 442 includes a teeth end 442A, a top end 442B and a hole or opening 443 disposed near a center of the pawl 442 that is sized and shaped to receive the pawl pin 446. The teeth end 442A of the pawl 442 includes teeth 444 configured to engage with the circumferential teeth 412 of the body 410. When assembled, in an embodiment including two pawls 442, two pawl pins 446 are disposed within the openings 443 of two pawls 442 such that each pawl 442 is supported by a respective pawl pin 446. The pawl retainer hub 440 includes openings that receive the two pawl pins 446 such that the two pawl pins 446 extend approximately parallel relative to one another and extend from the front end 402 of the knuckle joint 400 to the back end 404 of the knuckle joint 400. The assembly of the two pawls 442 and pawl pins 446 are disposed within the pawl retainer hub 440, as shown in FIG. 6F, such that the pawls 442 are disposed within the body 410.

FIG. 6F shows a cross-section of the knuckle joint 400 in a locked configuration. The top ends 442B of the two pawls 442 are disposed in a position that is displaced from the teeth ends 442A of the pawls 442. The position may be vertically above or may have a different orientation depending on the orientation of the knuckle joint 400. The top ends 442B of the pawls 442 are disposed directly adjacent to one another in a center of the body 410. The teeth ends 442A of the pawls 442 include teeth 444 that engage with the circumferential teeth 412 of the body 410. More specifically, if the inner surface of the body 410 was marked as the face of a clock, the teeth ends 442A of the two pawls 442 contact the circumferential teeth 412 of the body 410 at about 5 o'clock and 7 o'clock, respectively, as shown, for example, in FIG. 6G, although other configurations are contemplated as well. A spring element 450 and two pawl contact ball bearings 448 are disposed between the two pawls 442 and are configured to bias the teeth 444 of the pawls 442 towards the circumferential teeth 412 of the body 410, as shown, for example, in FIG. 6F. More specifically, the two ball bearings 448 contact inner surfaces of the pawls 442 and the spring element 450 is disposed between the two ball bearings 448 such that the two pawls 442 are under a constant biasing load or force from the spring element 450 acting on the two ball bearings 448 that contact each pawl 442, as shown in FIG. 6D, to cause the teeth 444 to engage the circumferential teeth 412.

The trigger button 432, illustrated as a substantially oval-shaped button (although it may be any suitable shape) that includes a front side and a back side. The front side of the trigger button 432 faces the front end 402 of the knuckle joint 400 and extends through the opening of the front side wall 424A of the outer shell 420, as shown in FIG. 5A. The engagement arm 434 is coupled to the back side of the trigger button 432 and extends outward therefrom such that the engagement arm 434 extends perpendicular to the trigger button 432, as shown in FIG. 6A. When assembled, the trigger button 432 and engagement arm 434 are disposed at the front end 402 of the knuckle joint 400 such that the engagement arm 434 extends into the pawl retainer hub 440 and the opening of the body 410 from the front end 402. The engagement arm 434 ends directly below the two top ends 442B of the pawls 442 such that the end of the engagement arm 434 contacts the two top ends 442B of the pawls 442, as shown in FIGS. 6D and 6F. The biasing spring 436 contacts the top of the engagement arm 434 at a middle portion in between the trigger button 432 and the two pawls 442, as shown in FIG. 6F. The engagement arm 434 and the trigger button 432 are retained by the dowel pin 441 (shown in FIG. 6B) extending through the pawl retainer hub 440.

The knuckle joint 400 acts as a pivot point for the upper arm 120 of the load support unit 100. More specifically, the bottom end 122 of the upper arm 120 is coupled to the knuckle joint 400. The actuator element 430 of the knuckle joint 400 includes a locked configuration and an unlocked configuration. When the actuator element 430 is in the locked configuration (FIGS. 6D, 6F, and 6G), the upper arm 120 is locked in place such that it cannot pivot at the knuckle joint 400 in a rotational direction. When the actuator element 430 is in the unlocked configuration (FIG. 6E), the teeth 444 of the pawls 442 disengage from the circumferential teeth 412 of the body 410 such that the upper arm 120 may pivot about the knuckle joint 400 in a rotational direction relative to the lower arm 110 of the load support unit 100, described in further detail below.

In the locked configuration, the teeth 444 disposed at the teeth ends 442A of the pawls 442 are engaged with the circumferential teeth 412 disposed on the inner surface of the body 410, as shown in FIGS. 6D, 6F, 6G. The engagement between the teeth 444 of the pawls 442 and the circumferential teeth 412 of the body 410 serves to lock rotation of the body 410 with respect to the pawl retainer hub 440. The pawl retainer hub 440 is secured to the outer shell 420, which is secured to the lower arm 110. The body 410 is secured to the upper arm. Thus, locking rotation between the body 410 and the pawl retainer hub 440 locks rotation between the upper arm 120 and the lower arm 110 by rendering the body 410 immovable with respect to the outer shell 420. When the teeth 444 of the pawls 442 are engaged with the circumferential teeth 412, the body 410 cannot rotate with respect to the outer shell 420. Contact between the top ends 442B of the pawls 442 with the engagement arm 434 prevents the left pawl 442 from rotating clockwise and prevents the right pawl 442 from rotating counterclockwise. Accordingly, forces tending to rotate the body 410 in either direction are opposed by at least one of the pawls 442. The engagement arm 434 and trigger button 432 are arranged such that the engagement arm 434 can be displaced in one direction (vertically upwards as shown, although this may vary according to orientation) from but not in an opposite direction (vertically downwards as shown, although this may vary according to orientation), thus providing a hard stop for the knuckle joint 400. Due to the structure and location of the pawls 442, the forces generated by rotational force applied to the body 410 are borne by the pawl pins 446 and engagement arm 434 and not the spring element 450. Accordingly, the strength of the knuckle joint 400 is not contingent upon the stiffness of the spring element 450. When the pawls 442 engage the body 410, rotation cannot be generated by applying additional force to overcome the spring element 450. This arrangement has the advantage of providing a durable and long-lasting joint because it does not have a friction component that can wear down and because weakening of the spring element 450 will not cause weakening of the joint.

To transition the actuator element 430 of the knuckle joint 400 from the locked configuration to the unlocked configuration, a user may push a bottom portion of the front side of the trigger button 432 inwards towards the body 410 of the knuckle joint 400. When the trigger button 432 is engaged, the engagement arm 434 coupled to the trigger button 432 is lifted in a direction towards the top ends 442B of the pawls 442 (vertically upwards as illustrated). When the engagement arm 434 moves towards the top ends 442B of the pawls 442, the biasing spring 436 provides resistance against the engagement arm 434 so that when the trigger button 432 is released, the biasing spring 436 will push the engagement arm 434 back to its resting position (horizontal, as illustrated) when the actuator element 430 is in the locked configuration. When the engagement arm 434 is displaced, the engagement arm 434 pushes the top ends 442B of the pawls 442 as well, in the same direction (vertically upwards as illustrated), as shown in FIG. 6E. As the top ends 442B of the pawls 442 are pushed, the two pawls 442 pivot about the pawl pins 446 disposed within the openings 443 of the pawls 442. As the two pawls 442 pivot in response to the engagement arm 434 movement, the teeth ends 442A of the two pawls 442 begin to move radially inwards towards one another. As the teeth ends 442A of the two pawls 442 pivot inwards, the teeth 444 on the teeth ends 442A of the two pawls 442 disengage from the circumferential teeth 412 of the body 410. As the teeth ends 442A of the two pawls 442 pivot inwards, the spring element 450 disposed between the two pawls 442 compresses. Once the teeth 444 of the actuator pawls 442 disengage from the circumferential teeth 412 of the body 410, the actuator element 430 of the knuckle joint 400 is in the unlocked configuration. When the knuckle joint 400 is in the unlocked configuration, the upper arm 120 of the load support unit 100 is able pivot in either direction radially around the axis of the knuckle joint 400, as the opening 122A disposed at the bottom end 122 of the upper arm 120 is circumferentially disposed around the knuckle joint 400 of the load support unit 100, as shown in FIG. 6E.

When the trigger button 432 is engaged and the knuckle joint 400 is in the unlocked configuration, a user can rotate the upper arm 120 of the load support unit 100 around the axis of the knuckle joint 400, pivoting from the knuckle joint 400 disposed at the bottom end 122 of the upper arm 120, until the desired position is reached. To return the actuator element 430 of the knuckle joint 400 to the locked configuration, a user releases the trigger button 432. When the trigger button 432 is released, the biasing spring 436 pushes the engagement arm 434 back to its resting position, as shown in FIG. 6G. When the engagement arm 434 moves away from the top ends 442B (e.g., downward in an embodiment as illustrated), the top ends 442B of the two pawls 442 are lowered as well. In this and further embodiments, the engagement arm 434 may move in a direction other than downward, depending on an orientation of the load support unit 100. As the top ends 442B of the two pawls 442 are displaced, the spring element 450 disposed between the teeth ends 442A of the two pawls 442 push the teeth ends 442A radially outwards such that the teeth 444 disposed on the teeth ends 442A of the pawls 442 contact the inner surface of the body 410. Once the teeth ends 442A of the pawls 442 contact the inner surface of the body 410, the teeth 444 at the teeth ends 442A of the pawls 442 align and engage with the circumferential teeth 412 of the body 410, locking the knuckle joint 400 in the desired position.

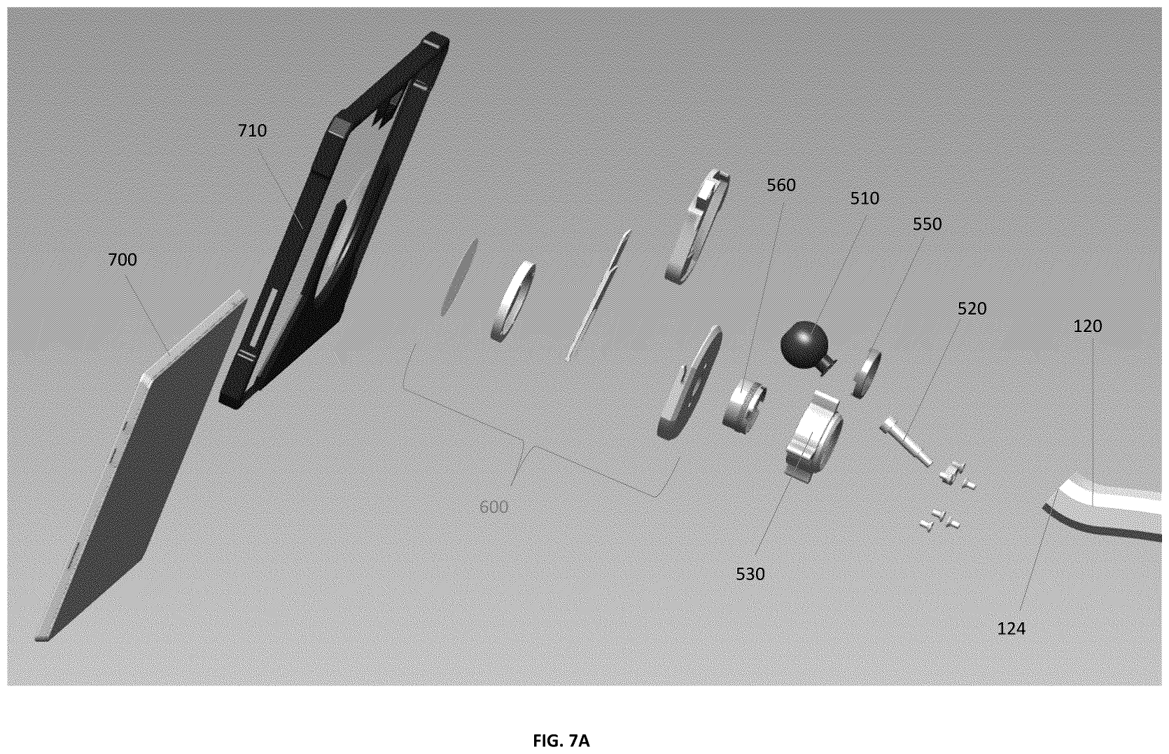

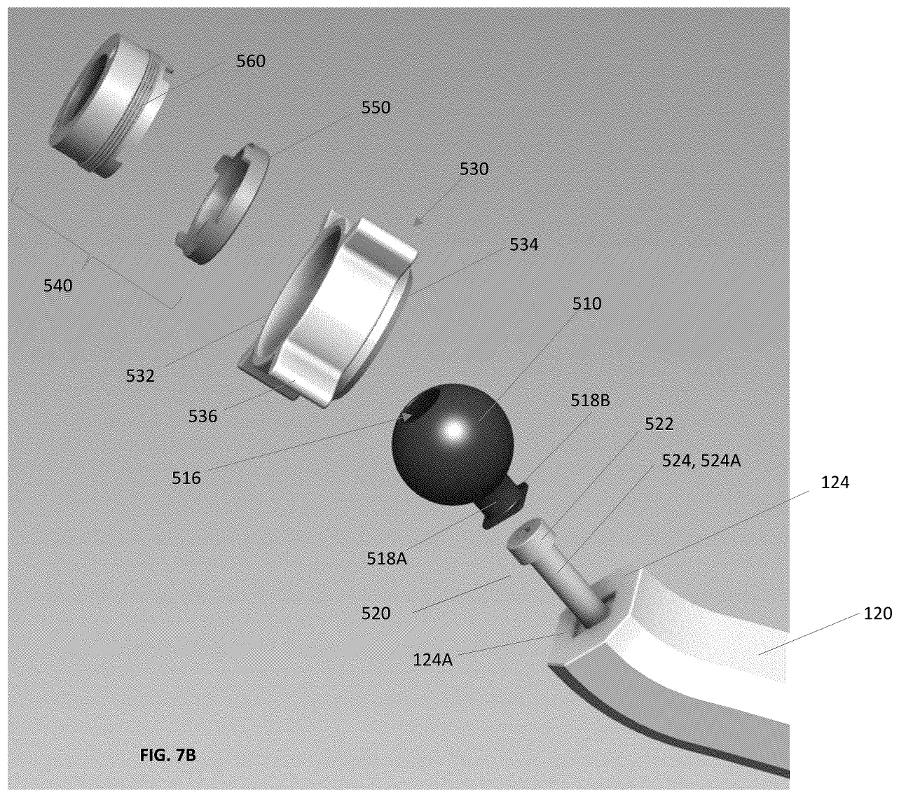

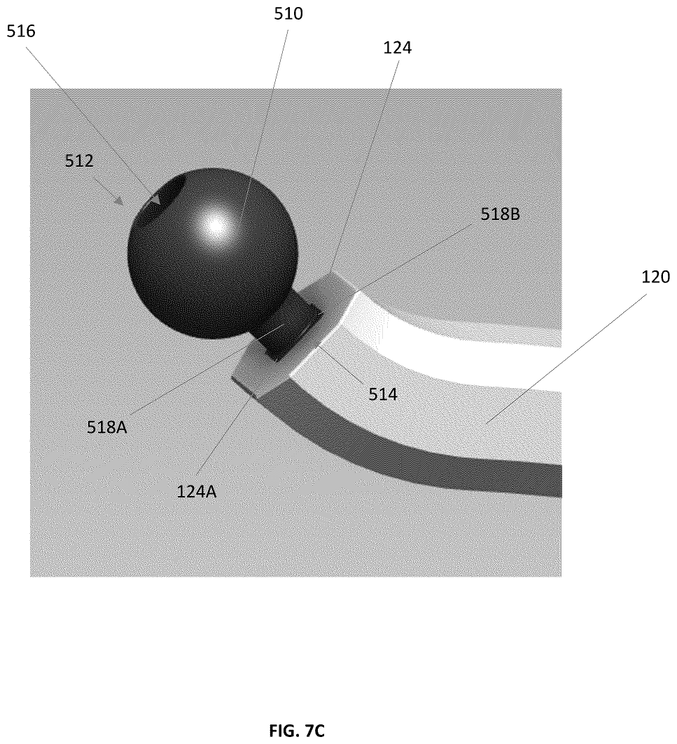

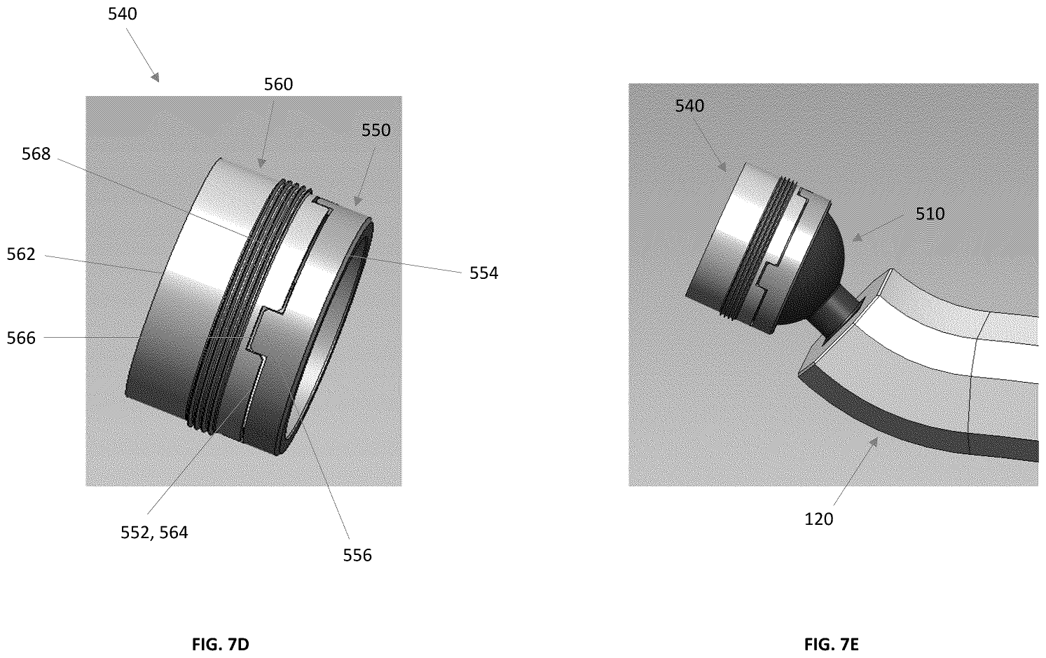

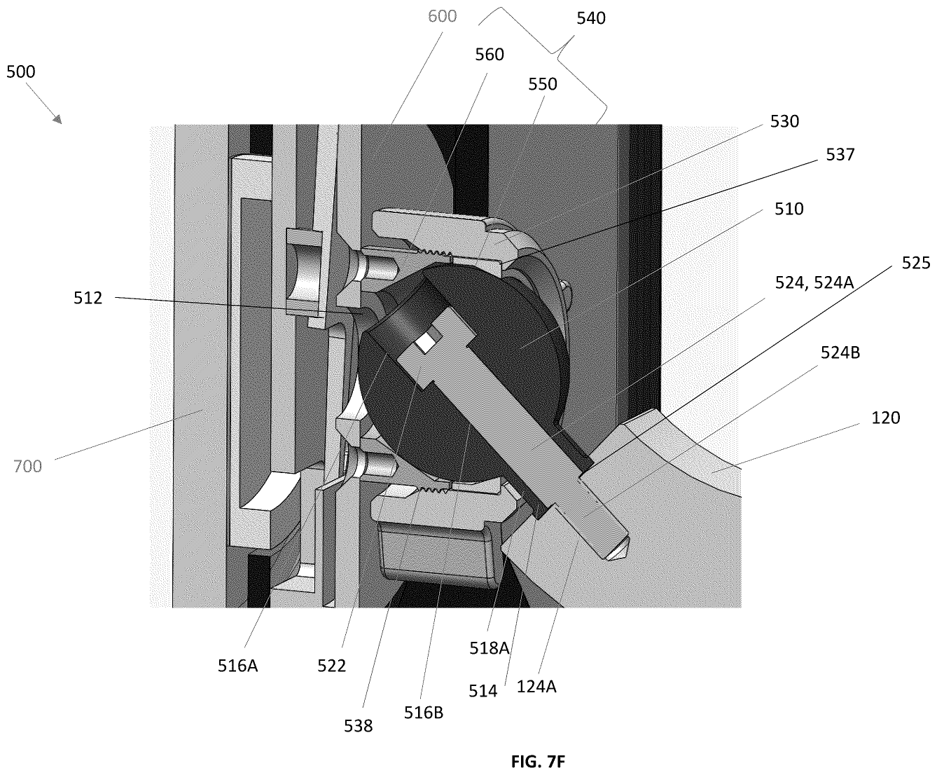

FIGS. 7A-7F illustrate the rotational joint 500 of the load support unit 100. As discussed above, the rotational joint 500 of the load support unit 100 is disposed at the load end 124 of the upper arm 120 and attaches a load 700 to the load support unit 100 via a load attachment device 600. The rotational joint 500 includes a rotator ball 510, a stem 520, a collar 530, a socket 540 having a first socket portion 550 and a second socket portion 560, and a load attachment device 600, as shown in FIG. 7A. The rotational joint 500 is configured to allow a user to rotate the load 700 about the load end 124 of the upper arm 120 to a desired position.

Referring now to FIGS. 7B and 7F, the stem 520 of the rotational joint 500 is a screw component that includes a head 522 and a body 524. The body 524 of the stem 520 is a cylindrically shaped longitudinal component that is coupled to a bottom end of the head 522 and extends therefrom. The body 524 of the stem 520 includes an upper portion 524A and a lower portion 524B. The upper portion 524A of the body 524 couples to the head 522 of the stem 520 and extends outwardly. The upper portion 524A of the body 524 may have a length of about 25 mm (i.e., in a range from 20-30 mm) and a diameter of about 8 mm (i.e., in a range from 6-10 mm). The end of the upper portion 524A meets the lower portion 524B at a shoulder or lip 525. At the lip 525 of the body 524, the upper portion 524A transitions to the lower portion 524B. The lower portion 524B of the body 524 of the stem 520 may be threaded and has a diameter that is smaller than the upper portion 524A of the body 524. The lower portion 524B of the body 524 has a length of about 11 mm (i.e., in a range from 9-13 mm) and a diameter of about 6 mm (i.e., in a range from 5-7 mm). The load end 124 of the upper arm 120 of the load support unit 100 includes a cavity 124A sized and shaped to receive the lower portion 524B of the stem 520 of the rotational joint 500 therewithin, as shown, for example, in FIGS. 7B and 7F, for example by engagement between threads of the lower portion 524B and threads of the cavity 124A. In further embodiments, the two components may be press-fitted or secured in any other suitable way. When assembled, the lower portion 524B of the stem 520 is disposed within the cavity 124A of the upper arm 120 such that the stem 520 extends longitudinally outward from the load end 124 of the upper arm 120 and the lip 525 abuts a surface of the upper arm 120 so as to positively locate the stem 520, as shown in FIG. 7F.

The rotator ball 510 is a sphere-shaped plastic, rubber, polymer element or any other suitable materials known to those of ordinary skill in the art, having a cylindrical opening 516 extending from a first end 512 to a second end 514 therethrough, as shown in FIG. 7B. The rotator ball 510 further includes a cylindrical extension or neck 518A that extends radially outward from a center of the rotator ball 510 and extends the length of the opening 516. A square-shaped stop 518B extends radially outward from the end of the neck 518A, as shown in FIG. 7B. The square-shaped stop 518B of the rotator ball 510 engages the square-shaped cavity 124A of the upper arm 120 to prevent the rotator ball 510 from rotating during an adjustment. The square-shaped stop 518B has a length of about 13 mm (i.e., in a range from 10-16 mm) and a width of about 1 mm (i.e., in a range from 0.8-1.2 mm). The rotator ball 510 may have a diameter of about 32 mm (i.e., in a range from 26-38 mm). The cylindrical opening 516 further includes an upper portion 516A and a lower portion 516B that meet at a shoulder or lip. The upper portion 516A of the opening 516 is disposed at the first end 512 of the rotator ball 510 and is sized and shaped to house or receive the head 522 of the stem 520, as shown in FIG. 7D. In embodiments, the rotator ball 510 and the stem 520 are formed integrally. The upper portion 516A may have a length of about 19 mm (i.e., in a range from 15-24 mm) and an inner diameter of about 8 mm (i.e., in a range from 6-10 mm). The lower portion 516B of the opening 516 is connected to the upper portion 516A and extends all the way to the second end 514 of the rotator ball and through the neck 518A. The lower portion 516B of the opening 516 is sized and shaped to house or receive the upper portion 524A of the stem 520 and has a length of about 25 mm (i.e., in a range from 20-30 mm) and an inner diameter of about 8 mm (i.e., in a range from 6-10 mm). When assembled, the stem 520 is disposed through the opening 516 of the rotator ball 510 at the first end 512 such that the lower portion 524B of the body 524 of the stem 520 extends through the opening 516 of the rotator ball 510 and exits the rotator ball 510 through the neck 518A at the second end 514. The stem 520 is slightly shorter than the length of the opening 516 of the rotator ball 510 to ensure a tightening effect when the stem 520 is installed and tightened. The stem 520 extends through the opening 516 of the rotator ball 510 until the head 522 of the stem 520 abuts the shoulder or lip within the opening 516 of the rotator ball 510 such that the upper portion 524A of the body 524 of the stem 520 is disposed within the lower portion 516B of the opening 516, the head 522 of the stem 520 is disposed within the upper portion 516A of the opening 516 and the lower portion 524B of the body 524 of the stem 520 is disposed within the cavity 124A of the upper arm 120, as shown in FIGS. 7C-7D. When assembled, the neck 518A of the rotator ball 510 abuts the load end 124 of the upper arm 120.

Referring now to FIGS. 7D and 7F, the rotational joint 500 further includes the collar 530 and the socket 540. The socket 540 further includes a first socket portion 550 and a second socket portion 560. The collar 530, first socket portion 550, and second socket portion 560 are hollow, ring-shaped elements comprising aluminum, steel, stainless steel and/or any other suitable materials known to those skilled in the art. The first socket portion 550 has a first end 552, a second end 554, an inner diameter of about 32 mm (i.e., in a range from 26-38 mm), an outer diameter of about 34 mm (i.e., in a range from 27-41 mm) and a length of about 5 mm (i.e., in a range from 4-6 mm). The first socket portion 550 further includes substantially square-shaped flanges 556 that extend from the first end 552 of the first socket portion 550, as shown in FIG. 7B. The square-shaped flanges 556 may be equidistantly spaced apart around the circumference of the first socket portion 550. In the embodiment shown, the first socket portion 550 includes exactly four flanges 556 spaced substantially 90 degrees from one another, however this is not meant to be limiting, as the first socket portion 550 can include more or fewer than four flanges 556. Further, the flanges 556 may be spaced in an irregular or asymmetric manner. The flanges 556 may extend about 2.5 mm (i.e., in a range from 2-3 mm) from the first end 552 of the first socket portion 550 and may have a width of about 6 mm (i.e., in a range from 5-7 mm).

The second socket portion 560 has a first end 562, a second end 564, an inner diameter of about 32 mm (i.e., in a range from 26-38 mm), an outer diameter of about 34 mm (i.e., in a range from 27-41 mm) and a length of about 16 mm (i.e., in a range from 13-19 mm). The second socket portion 560 includes substantially square-shaped cutouts 566 on the second end 564 of the second socket portion, as shown in FIG. 7B. The square-shaped cutouts 566 are equidistantly spaced apart around the circumference of the second socket portion 560. In the embodiment shown, the second socket portion 560 includes exactly four cutouts 566 spaced substantially 90 degrees from one another, however this is not meant to be limiting, as the second socket portion 560 can include more or fewer than four cutouts 566. The cutouts 566 extend about 2.5 mm (i.e., in a range from 2-3 mm) in from the second end 564 of the second socket portion 560 and have a width of about 6 mm (i.e., in a range from 5-7 mm). The cutouts 566 of the second socket portion 560 are sized and shaped to receive the flanges 556 of the first socket portion 550, as shown, for example, in FIGS. 7D-7E. The cutouts 566 of the second socket portion 560 and the flanges 556 of the first socket portion 550 are radially aligned such that each cutout 566 of the second socket portion 560 receives one of the flanges 556 of the first socket portion 550, as shown in FIG. 7D. The first socket portion 550 is keyed to the second socket portion 560 via the flanges 556 and cutouts 566 to prevent relative rotation between the first socket portion 550 and the second socket portion 560. When the first socket portion 550 and the second socket portion 560 are coupled via the flanges 556 and cutouts 566, the first socket portion 550 cannot rotate relative to the second socket portion 560 and the second socket portion 560 cannot rotate relative to the first socket portion 550. The second socket portion 560 further includes external threads 568 on an outer surface of the second socket portion 560 that are configured to mate with internal threads of the collar 530, described in further detail below.

The assembly of the first socket portion 550 and the second socket portion 560, referred to as the socket 540, is configured to receive the rotator ball 510 of the rotational joint 500 within the hollow opening of the socket 540, as shown in FIGS. 7E and 7F. A portion of the rotator ball 510 fits within the hollow opening of the socket 540 such that the first end 512 of the rotator ball 510 is disposed radially inward relative to the socket 540. The hollow opening of the socket 540 is formed from the interior walls of the first socket portion 550 and the second socket portion 560. The hollow opening is configured so as to be larger in diameter in the center and is therefore configured to trap or lock the rotator ball 510 within. The socket 540 may not cover or enclose the entire rotator ball 510, as shown in FIG. 7E. The socket 540 may be configured to rotate about the rotator ball 510, described in further detail below.

The collar 530 of the rotational joint 500 is a hollow, ring-shaped element with a first end 532, a second end 534, an inner diameter of about 34 mm (i.e., in a range from 27-41 mm), an outer diameter of about 45 mm (i.e., in a range from 36-54 mm) and a length of about 23 mm (i.e., in a range from 19-27 mm). The collar 530 includes tabs 536 spaced apart from one another around the circumference of the collar 530 and extending radially outward from the outer surface of the collar 530, as shown in FIG. 7B. The tabs 536 may extend about 10 mm (i.e., in a range from 8-12 mm) radially outward from the outer surface of the collar 530 and may extend over an entire length or a portion of the length of the collar 530. In the embodiment shown, the collar 530 includes exactly four tabs 536 spaced substantially 90 degrees apart from one another, however this is not meant to be limiting, as the collar 530 can include more or fewer than four tabs 536. The tabs 536 may provide a user with a better grip for turning the collar 530.

The collar 530 further includes internal threads 538 disposed on an inner surface of the collar 530. When assembled, the collar 530 is configured to cover or enclose the socket 540 of the rotational joint 500, as shown, for example, in FIG. 7F. The internal threads 538 of the collar 530 are configured to mate with the external threads 568 of the second socket portion 560 such that the collar 530 is effectively coupled to the socket 540, as shown in FIG. 7F. The collar 530 is configured to secure the rotator ball 510 within the socket 540 by tightening the first socket portion 550 to the second socket portion, as shown in FIG. 7F. The first socket portion 550 is captured laterally by a lip 537 disposed at the second end 534 of the collar 530. When the collar 530 is tightened (e.g., rotated with respect to) the second socket portion 560, the engagement between the external threads 568 and the internal threads 538 draw the second socket portion 560 towards the first socket portion 550. The first socket portion 550 is arrested by the lip 537 and further tightening causes the second socket portion to be drawn into contact with the rotator ball 510. The level of rotational resistance between the socket 540 and the rotator ball 510 is set by the collar 530. The collar 530 is able to tighten the second socket portion 560 towards the first socket portion 550 by rotating the collar 530 via the tabs 536 on the outer surface of the collar 530. Rotation of the collar 530 screws the collar 530 into the second socket portion 560 via the internal threads 538 of the collar 530 and the exterior threads 568 of the second socket portion 560, which pulls the first socket portion 550 towards the second socket portion 560 while the flanges 556 of the first socket portion 550 engage with the cutouts 566 to prevent the first socket portion 550 and the second socket portion 560 from rotating relative to one another. This, in turn, tightens the socket 540 around the outer surface of the rotator ball 510 which increases the level of rotation resistance between the socket 540 and the rotator ball 510. The level of rotation resistance can be decreased by unscrewing the collar 530 from the second socket portion 560. Because the first socket portion 550 and the second socket portion 560 are rotationally locked to one another, rotation of the rotator ball 510 within the socket 540 does not cause loosening of the collar 530.

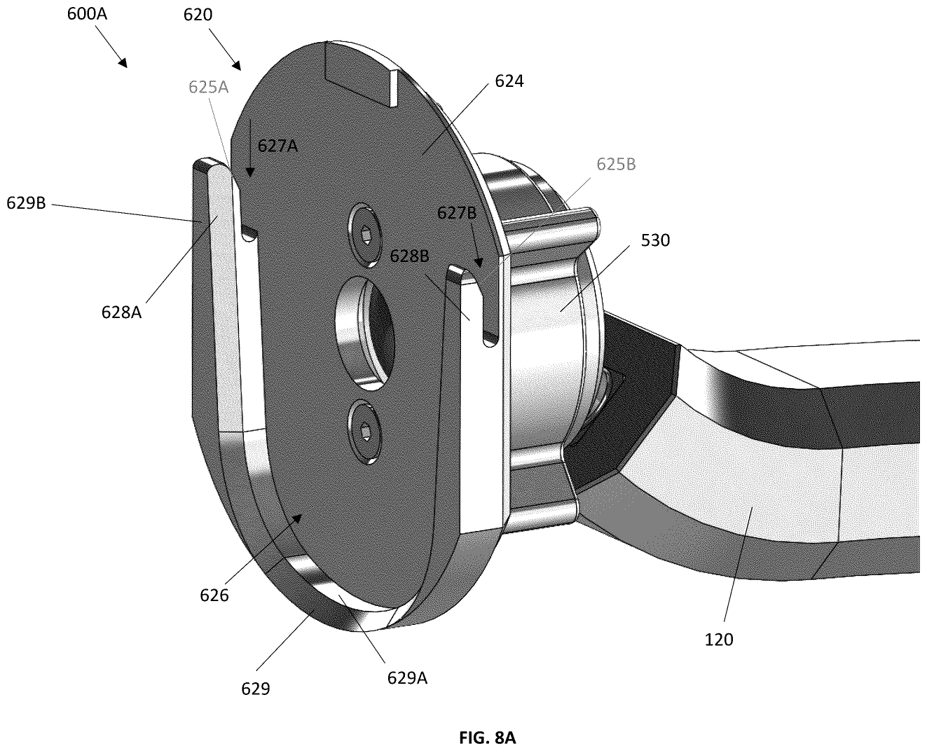

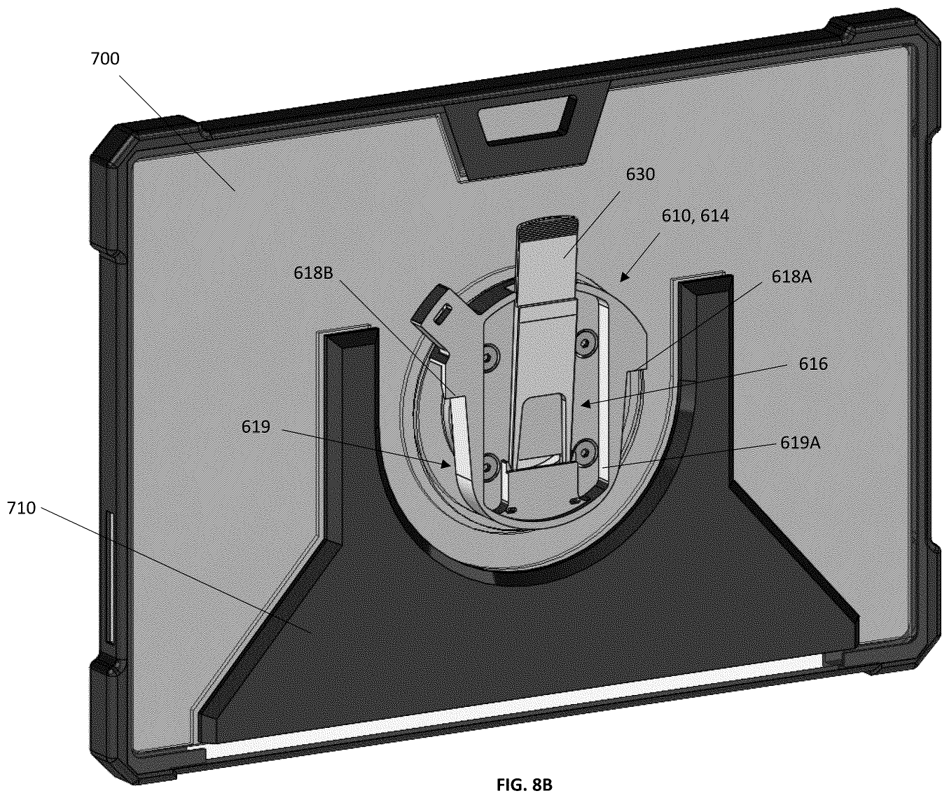

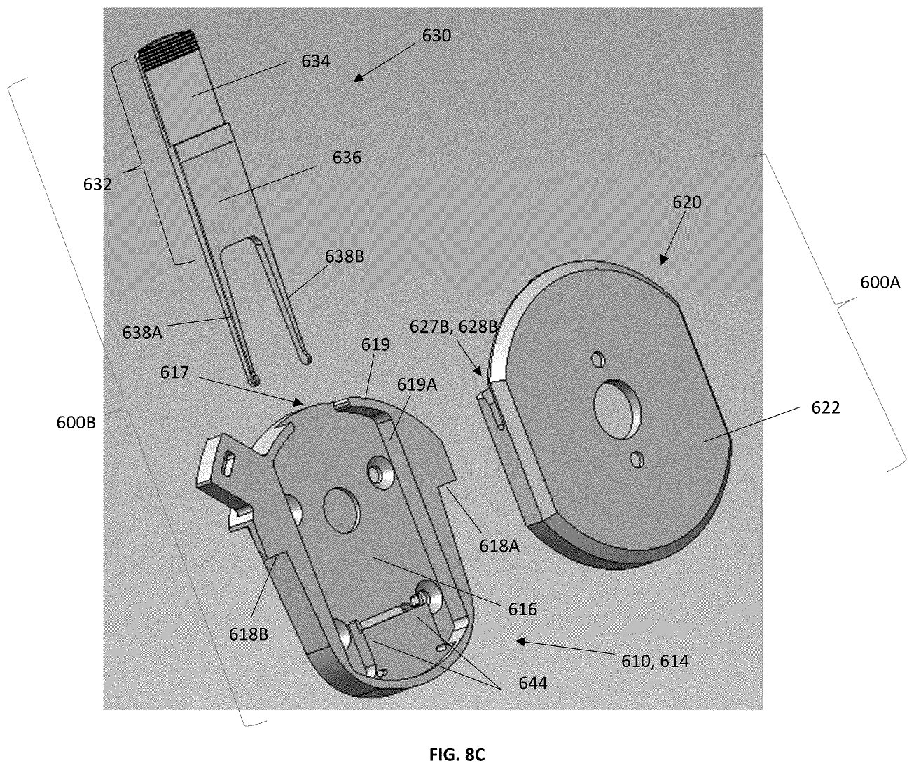

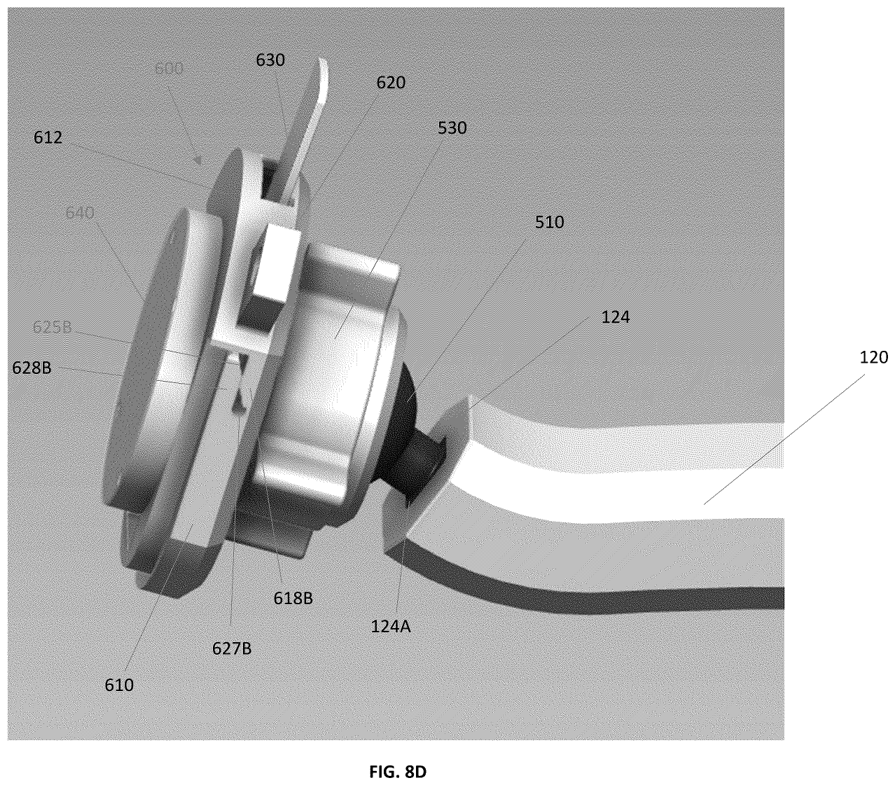

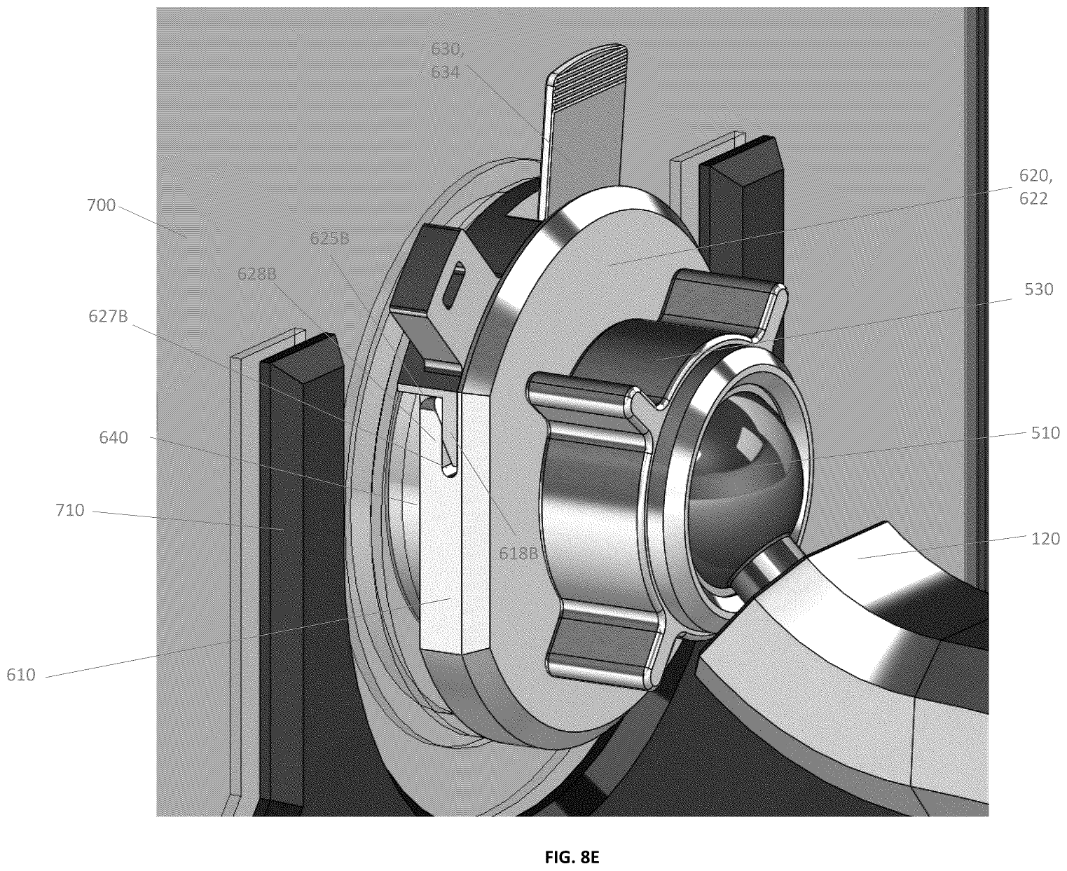

The load support unit 100 further includes a load attachment device 600 as shown in FIGS. 8A-8E. In the embodiment shown and described herein, the load support unit 100 is configured to support a tablet or similar load 700, as shown in FIGS. 8B and 8E. However, this is not meant to be limiting, as the load support unit 100 may be used to support any object or load, for example, a book, notebook, computer, display screen, microphone, or any other device or object.

The load attachment device 600 in FIG. 8A includes a joint unit 600A and a load unit 600B. The joint unit 600A is coupled to the second socket portion 560 (which cannot be seen in FIG. 8A) of the rotational joint 500 and includes a back portion 620 of the load attachment device 600, as shown in FIG. 8A. The load unit 600B is coupled to the load 700 and includes a front portion 610 of the load attachment device 600 and a coupling portion 640, as shown in FIGS. 8B and 8D. The load attachment device 600 further includes a spring-loaded locking tab 630 that allows the front portion 610 and the back portion 620 of the load attachment device 600 to lock and unlock from one another.

The back portion 620 of the load attachment device 600 is substantially oval-shaped and includes an inward facing side 622, shown in FIG. 8C, and an outward facing side 624 opposite of the inward facing side 622, shown in FIG. 8A. The inward facing side 622 of the back portion 620 faces the rotational joint 500 at the load end 124 of the upper arm 120. The inward facing side 622 of the back portion 620 is coupled to the second socket portion 560 of the socket 540 via screws or other suitable attachment devices, as shown in FIGS. 8A and 8D-8E. As such, the inward facing side 622 of the back portion 620 of the load attachment device 600 abuts the second socket portion 560 and the collar 530 of the rotational joint 500.

The outward facing side 624 of the back portion 620 faces away from the rotational joint 500 of the load support unit 100. The outward facing side 624 of the back portion 620 includes a tapered cavity 626 defined by a border 629 that lines a bottom edge and at least portions of two side edges of the outward facing side 624. At least a top portion or edge of the outward facing side 624 remains open and unobstructed by the border 629. The border 629 protrudes outwardly from the outward facing side 624, creating the tapered cavity 626. The border 629 includes a border face 629B disposed substantially parallel to the outward facing side 624. The border 629 is substantially U-shaped, however an internal surface 629A of the border 629 (and substantially perpendicular to the border face 629B) angles outwardly towards a top portion of the outward facing side 624 such that the tapered cavity 626 is flared at the top portion of the outward facing side 624 and tapers or narrows towards a bottom portion of the outward facing side 624, as shown in FIG. 8A. The border 629 includes two top portions at the two ends of the “U” shape. At the top portions of the border 629, the border 629 includes two extending arms or extensions 628A, 628B that form an overhang on each side of the top portions of the border 629, as shown in FIG. 8A. The two extensions 628A, 628B of the border 629 are spaced from the outward facing side 624 of the back portion 620 such that two slots 627A, 627B are formed in between the outward facing side 624 of the back portion 620 and the two extensions 628A, 628B. Disposed at the top portions of the border 629, e.g., at the extensions 628A, 628B of the “U” shape, the border 629 further includes two chamfered edges 625A, 625B that extend from either extension 628A, 628B of the “U” and provide an angled transition from the border face 629B to the internal surface 629A, as shown in FIG. 8A.

The front portion 610 of the load attachment device 600 is approximately oval-shaped with a shape adapted to conform to the border 629, as discussed below, and includes a load side 612, shown in FIG. 8D, and an attachment side 614 opposite of the load side 612, shown in FIGS. 8B and 8C. The load side 612 of the front portion 610 faces outward and away from the rotational joint 500, and the attachment side 614 of the front portion 610 faces toward the back portion 620 of the load attachment device 600. The load side 612 of the front portion 610 further includes a cylindrical-shaped coupling portion 640, as shown in FIGS. 8D-8E. The coupling portion 640 is attached to the load 700 using double-sided, pressure sensitive adhesive. However, this is not meant to be limiting, as the coupling portion 640 can be attached to the load 700 using glue-based adhesives, mechanical means such as screws, bolts, fasteners, and/or any other suitable means known to those skilled in the art. The coupling portion 640 is sized and shaped to fit within an opening in a protective covering 710 that is coupled to the load 700, as shown in FIGS. 8B and 8E.

The attachment side 614 of the front portion 610 faces towards the outward facing side 624 of the back portion 620 of the load attachment device 600, as can be seen in the exploded view in FIG. 8C. The attachment side 614 of the front portion 610 includes a cavity 616, which may be tapered, defined by a border 619 that lines at least portions of the edges of the attachment side 614. An opening 617 in the border 619 at a top portion of the attachment side 614 may be provided, as can be seen in FIGS. 8B and 8C. The border 619 protrudes outwardly from the attachment side 614, creating the cavity 616. An internal surface 619A of the border 619 may angle outwardly towards the top portion of the attachment side 614 such that the cavity 616 is flared at the top portion of the attachment side 614 and tapers or narrows towards a bottom portion of the attachment side 614, as shown in FIGS. 8B-8C. The border 619 further includes two tabs 618A, 618B that extend outward from the two sides of the attachment side 614, as shown in FIGS. 8B-8C. The two tabs 618A, 618B are sized and shaped to slide and fit within the two slots 627A, 627B of the back portion 620, as described below.

The locking tab 630 of the load attachment device 600 is an approximately flat, substantially rectangular piece that includes a body 632 and two prongs 638A, 638B that extend from the body 632 and are substantially parallel with one another. The locking tab 630 is inserted within the cavity 616 of the attachment side 614 of the front portion 610, as shown in FIGS. 8B-8C. The body 632 further includes an outer portion 634 and an inner portion 636. The outer portion 634 of the locking tab 630 extends out from the cavity 616 of the front portion 610 and the inner portion 636 is disposed within the cavity 616 of the front portion 610, as shown in FIG. 8B. The two prongs 638A, 638B extend from the inner portion 636 of the body 632 and are advanced into prong pockets 644 within the attachment side 614 of the front portion 610 of the load attachment device 600, as can be seen in FIG. 8B.

The locking tab 630 is disposed within the attachment side 614 of the front portion 610 of the load attachment device 600, the prongs 638A, 638B of the locking tab 630 are advanced though the opening 617 in the top portion of the border 619 until the prongs 638A, 638B are inserted within the prong pockets 644 that are disposed at a bottom portion of the cavity 616 and the inner portion 636 of the body 632 is disposed within the cavity 616 of the attachment side 614, as shown in FIG. 8B. Once the locking tab 630 is in place, the outer portion 634 of the body 632 extends outwardly from the opening 617 of the border 619, as shown in FIG. 8B.

To lock the front portion 610 of the load attachment device 600 to the back portion 620 of the load attachment device 600, the attachment side 614 of the front portion 610 slides against the outward facing side 624 of the back portion 620 until the tabs 618A, 618B of the front portion 610 slide into the slots 627A, 627B of the back portion 620 that are formed by the extensions 628A, 628B of the border 629 disposed on each side of the back portion 620, as shown in FIGS. 8D-8E. The outer portion 634 of the locking tab 630 is biased towards the back portion 620 of the load attachment device 600, i.e., in a direction towards the rotational joint 500, by a spring (not shown) or other biasing means. When the front portion 610 is locked to the back portion 620, the prongs 638A, 638B of the locking tab 630 push the back portion 620 away from the front portion 610 of the load attachment device 600. By pushing the back portion 620 away from the front portion 610 of the load attachment device 600, the pressure between the extensions 628A, 628B of the back portion 620 and the tabs 618A, 618B of the front portion 610 holds both the front portion 610 and the back portion 620 in place. When a user attaches the load 700 with the front portion 610 of the load attachment device 600 to the back portion 620 of the load attachment device 600, it is often hard to see, for instance, when the load 700 is a tablet and blocks a user's field of view. The chamfered edges 625A, 625B of the extensions 628A, 628B provide wide lead-ins when the tabs 618A, 618B are being inserted within the slots 627A, 627B of the back portion 620 to assist with guiding the tabs 618A, 618B into the slots 627A, 627B. In addition, the cavities 616, 626 of the front and back portion 610, 620 of the load attachment device 600 provide wide lead-ins when the front portion 610 slides against the back portion 620 to assist with guiding and aligning the tabs 618A, 618B of the front portion 610 into the slots 627A, 627B of the back portion 620 when a user cannot see.

To unlock the front portion 610 of the load attachment device 600 from the back portion 620 of the load attachment device 600, the outer portion 634 of the locking tab 630 can be pushed or pressed towards the load 700, i.e., in a direction away from the rotational joint 500, such that the prongs 638A, 638B of the locking tab 630 no longer push the back portion 620 away from the front portion 610 of the load attachment device 600. By reducing or eliminating the pressure between the extensions 628A, 628B of the back portion 620 and the tabs 618A, 618B of the front portion 610, a user is able to pull or lift the load 700, along with the front portion 610 of the load attachment device 600, up and away from the back portion 620 of the load attachment device 600.

As can be seen in FIG. 8E, the coupling portion 640 is coupled to the protective covering 710 of the load 700 and the load side 612 of the front portion 610 of the load attachment device 600. The attachment side 614 of the front portion 610 of the load attachment device 600 is securely locked to the outward facing side 624 of the back portion 620 of the load attachment device 600, and the inward facing side 622 of the back portion 620 of the load attachment device 600 is secured to the socket 540 of the rotational joint 500.

When the load attachment device 600 is effectively coupled to the socket 540 of the rotational joint 500 and the load 700 is effectively coupled to the load attachment device 600, then the load 700 is effectively coupled to the load support unit 100, as shown, for example, in FIGS. 1A-1B. A user is then able to freely rotate the load 700 about the rotator ball 510 to a desired position via the load attachment device 600, the socket 540 and the collar 530. The socket 540 and collar 530 of the rotational joint 500 can be loosened to allow a user to adjust the orientation of the load 700 about the rotator ball 510 and can be tightened to keep the load 700 in place once a user is done adjusting the load 700 and releases the load 700.

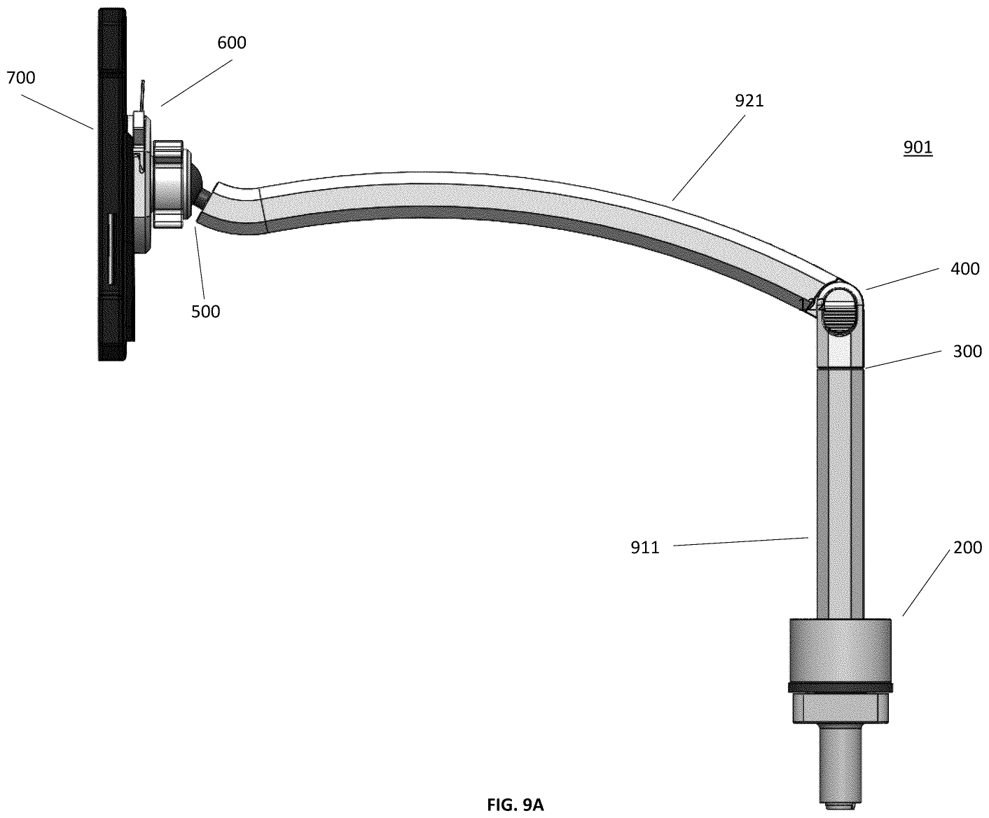

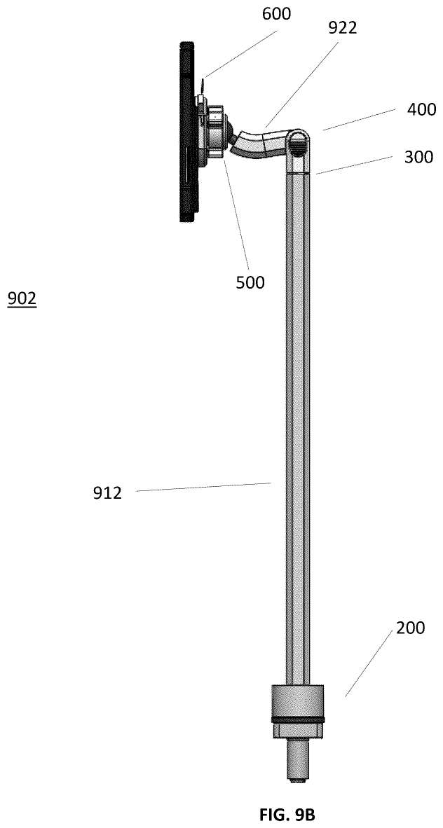

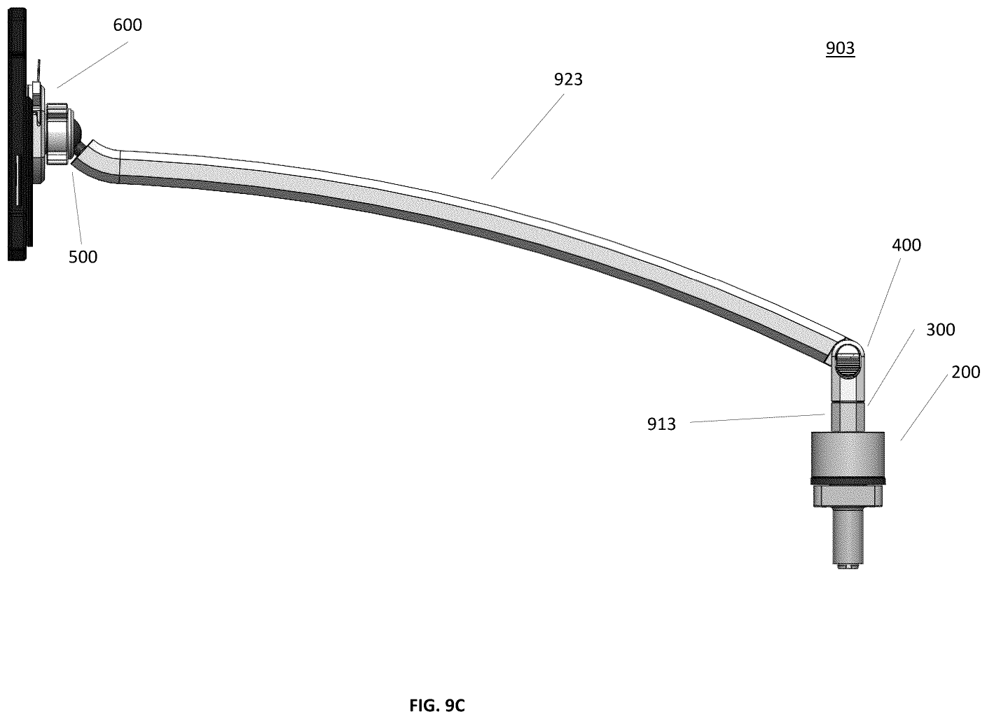

FIGS. 9A-9C illustrate load support units having different dimensions consistent with embodiments hereof. Load support units 901, 902, and 903 (FIGS. 9A, 9B, 9C) are each similar to load support unit 100 and may include any combination of the components of load support unit 100. Each of load support units 901, 902, and 903 include a mounting swivel 200, a swivel joint 300, a knuckle joint 400 and a rotational joint 500, as described herein. As discussed above, these components are designed and adapted to provide robust support to a load 700 coupled to a load support device 600. Load support units, as described herein, are not limited to the dimensions and/or shape of load support unit 100. FIGS. 9A, 9B, and 9C provide examples of load support units 901/902/903 having upper and lower arms of alternative dimensions. The load support units 901/902/903 are illustrative only, and do not limit the potential configurations of the upper and lower arms of load support units consistent with embodiments hereof. The advantages provided by the mounting swivel 200, a swivel joint 300, a knuckle joint 400 and a rotational joint 500, as described herein, permit the mounting of loads with large moment arms that may generate significant amounts of torque. The strength and robustness of these joints and swivels, however, permit such mounting while reducing adverse consequences that may otherwise be associated with such mounting.

FIG. 9A illustrates a load support unit 901 having lower arm 911 and an upper arm 921 of greater length the lower arm 911. As illustrated in FIG. 9A, the upper arm 921 may be curved while the lower arm 911 may be straight and substantially vertical. The upper arm 921 may be in a range between 1.5 and 3.5 times as long as the lower arm 911. FIG. 9B illustrates a load support unit 902 having a lower arm 912 and an upper arm 922 of shorter length than the lower arm 912. The upper arm 922 may be in a range between 5 and 10 times shorter than the lower arm 912. As illustrated in FIG. 9B, the upper arm 922 may be curved while the lower arm 912 may be straight and substantially vertical. FIG. 9C illustrates a load support unit 903 having a lower arm 913 and an upper arm 923 of greater length than the lower arm 913. As illustrated in FIG. 9C, the upper arm 923 may be curved while the lower arm 913 may be straight and substantially vertical. The upper arm 923 may be in a range between 5 and 15 times longer than the lower arm 913. Table 1 below provides example measurements of the length of the upper and lower arms for each of the load support units 901, 902, and 903. In each of the load support units 901, 902, and 903, the lower arms 911/912/913 is straight and arranged in a substantially vertical fashion and the upper arms 921/922/923 are curved. Such an arrangement is not required and the lower arms 911/912/913 may extend from the mounting swivel 200 at different angles and distances and may be curved. The upper arms 921/922/923 may be straight and may extend from the lower arms 911/912/913 at different angles and/or distances.

| Load Support Unit | Upper Arm Length | Lower Arm Length |
|---|---|---|
| 901 | 7.34″ | 15″ |
| 902 | 25.3″ | 3.2″ |
| 903 | 2.5″ | 25.5″ |

FIG. 10 shows the load support unit 100 coupled to a cart. The load support unit 100 supports the load 700 above the cart. However, this is not meant to be limiting, as this is only one example use of the load support unit 100. The load support unit 100 may be mounted to any surface and extend orthogonally therefrom.

It should be understood that the load support unit described herein is provided as an example and is not intended to limit the invention or the application and uses of the invention. It should be understood that various embodiments disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single device or component for purposes of clarity, it should be understood that the techniques of this disclosure may be performed by a combination of devices or components.

Further embodiments of the disclosure include the following.

Embodiment 1 is a knuckle joint configured for connecting a lower arm and an upper arm. The knuckle joint comprises an outer shell, a body sized and shaped to fit within an opening of the upper arm, and an actuator element. The actuator element includes a trigger button disposed exterior to the body and includes an engagement arm extending therefrom and into the body, at least one actuator pawl disposed within an interior surface of the body, a biasing spring configured to bias the engagement arm away from interaction with the at least one actuator pawl, and a spring element configured to bias the at least one actuator pawl towards the interior surface of the body. When the trigger button is engaged, the engagement arm interacts with the at least one actuator pawl such that the knuckle joint is in an unlocked configuration.

Embodiment 2 is the knuckle joint of embodiment 1, wherein the body includes circumferential teeth on an interior surface of the body and the at least one actuator pawl includes teeth configured to engage the circumferential teeth of the body.

Embodiment 3 is the knuckle joint of embodiment 2, wherein when the trigger button is engaged, the engagement arm interacts with the at least one actuator pawl such that the teeth of the at least one actuator pawl disengage from the circumferential teeth of the body such that the knuckle joint is in an unlocked configuration, and wherein when the trigger button is released, the engagement arm is biased by the biasing spring and does not interact with the at least one actuator pawl such that the teeth of the at least one actuator pawl engage the circumferential teeth of the body such that the knuckle joint is in a locked configuration.

Embodiment 4 is the knuckle joint of any of embodiments 1-3, wherein the knuckle joint includes exactly two actuator pawls.

Embodiment 5 is the knuckle joint of any of embodiments 1-4, wherein the outer shell further includes an opening configured to accommodate the trigger button of the actuator element.

Embodiment 6 is the knuckle joint of any of embodiments 3-5, wherein when the knuckle joint is in the unlocked configuration, the body is moveable relative to the outer shell.

Embodiment 7 is the knuckle joint of any of embodiments 3-6, wherein when the knuckle joint is in the locked configuration, the body is immovable relative to the outer shell.

Embodiment 8 is the knuckle joint of any of embodiments 3-7, wherein the teeth of the at least one actuator pawl prevent rotation of the body relative to the outer shell in the locked configuration.

Embodiment 9 is the knuckle joint of any of embodiments 4-8, wherein a first one of the two actuator pawls prevents rotation of the body relative to the outer shell in a first direction and a second one of the two actuator pawls prevents rotation of the body relative to the outer shell in a second direction.

Embodiment 10 is the knuckle joint of any of embodiments 1-9, wherein an outer surface of the body includes a plurality of faces, each face configured to engage a corresponding face of an inner surface of the opening of the upper arm.

Embodiment 11 is the knuckle joint of any of embodiments 3-10, wherein, in the locked configuration, engagement between the teeth of the at least one actuator pawl and the circumferential teeth is a face to face engagement.

Embodiment 12 is the knuckle joint of embodiment 11, wherein a biasing force provided by the spring element is provided in a different direction than a support force generated by the face to face engagement.

Embodiment 13 is a swivel joint configured for connecting a lower arm and a upper arm. The swivel joint comprises an outer shell, a first tapered bushing having a first circumferential opening through a center thereof, a second tapered bushing having a second circumferential opening through a center thereof, and a shoulder screw. The first tapered bushing is rotationally keyed to the shoulder screw to prevent relative rotation with the shoulder screw and provide friction during relative rotation with the outer shell.

Embodiment 14 is the swivel joint of embodiment 13, wherein the outer shell is configured with a tapered interior cavity, the first tapered bushing is disposed within the tapered interior cavity of the outer shell, and the second tapered bushing is configured to rest within a tapered well of the lower arm.

Embodiment 15 is the swivel joint of embodiment 14, wherein the shoulder screw is sized and shaped to fit within the tapered interior cavity, the first circumferential opening of the first tapered bushing and the second circumferential opening of the second tapered bushing.

Embodiment 16 is the swivel joint of embodiment 15, wherein the shoulder screw is configured to engage with a screw hole in the tapered well.

Embodiment 17 is the swivel joint of any of embodiments 14-16, further comprising a first biasing element configured to bias the first tapered bushing into the tapered interior cavity and a second biasing element configured to bias the second tapered bushing into the tapered well.

Embodiment 18 is the swivel joint of embodiment 17, wherein the second tapered bushing is rotationally keyed to the outer shell to prevent relative rotation with the outer shell and provide friction during relative rotation with the tapered well.

Embodiment 19 is the swivel joint of any of embodiments 13-18, wherein the second tapered bushing has a circumference larger than a circumference of the first tapered bushing.

Embodiment 20 is the swivel joint of any of embodiments 17-19, wherein the first biasing element is configured to bias the first tapered bushing further into the tapered interior cavity as a surface of the first tapered bushing is worn.

Embodiment 21 is the swivel joint of any of embodiments 17-20, wherein the second biasing element is configured to bias the second tapered bushing further into the tapered well as a surface of the second tapered bushing is worn.

Embodiment 22 is the swivel joint of any of embodiments 16-21, wherein the swivel joint is configured to provide friction for relative rotation between the upper arm and the lower arm when the shoulder screw engages with the screw hole in the tapered well and the lower arm is coupled to the outer shell.

Embodiment 23 is a mounting swivel configured for supporting an arm. The mounting swivel comprises a base plate configured for coupling to the arm, a holder post extending from the base plate, wherein the holder post includes at least one keyway, and a base adapter configured to receive the holder post. The base adapter includes a base block, wherein the base block further includes at least one keyway, and a base socket extending form the base block. The mounting swivel further comprises a friction stack including a plurality of clutch plates, a plurality of friction plates disposed between respective ones of the plurality of clutch plates, and a spring element. The base socket of the base adapter is configured to house the holder post of the lower arm. The rotation of the holder post causes conforming rotation of the plurality of friction plates relative to the plurality of clutch plates. The rotation of the plurality of friction plates relative to the plurality of clutch plates causes resistance to the rotation of the holder post.

Embodiment 24 is the mounting swivel of embodiment 23, wherein the base block includes a cylindrical cavity defined by a circumferential wall.

Embodiment 25 is the mounting swivel of embodiment 24, wherein the at least one keyway of the base block is disposed in the circumferential wall of the base block.

Embodiment 26 is the mounting swivel of any of embodiments 23-25, wherein the holder post extends longitudinally from the base plate.

Embodiment 27 is the mounting swivel of any of embodiments 23-26, wherein the base socket is configured to house the holder post of the lower arm.

Embodiment 28 is the mounting swivel of any of embodiments 23-27, wherein the spring element is configured to provide a biasing force to the friction stack.

Embodiment 29 is the mounting swivel of any of embodiments 23-28, wherein the holder post is rotatable in relation to the base adapter.

Embodiment 30 is the mounting swivel of any of embodiments 23-29, wherein the plurality of clutch plates are rotationally locked to the base block.

Embodiment 31 is the mounting swivel of any of embodiments 25-30, wherein each of the plurality of clutch plates includes at least one key configured to engage the at least one keyway in the circumferential wall of the base block.

Embodiment 32 is the mounting swivel of any of embodiments 23-31, wherein the plurality of friction plates are rotationally locked to the holder post.

Embodiment 33 is the mounting swivel of embodiment 32, wherein each of the plurality of friction plates include at least one key configured for engaging the at least one keyway of the holder post.

Embodiment 34 is the mounting swivel of any of embodiments 23-33, wherein the base adapter is configured to attach to a cart.

Embodiment 35 is the mounting swivel of any of embodiments 23-34, wherein the mounting swivel includes exactly three clutch plates.

Embodiment 36 is the mounting swivel of any of embodiments 23-35, wherein the mounting swivel includes exactly two friction plates.

Embodiment 37 is the mounting swivel of any of embodiments 23-36, further comprising a latch extending from the base plate and disposed in a pocket of the holder post.

Embodiment 38 is a rotational joint configured for supporting a load at an end of an arm. The rotational joint comprises a ball attachment including a rotator ball and a stem, a socket configured to accommodate the rotator ball, the socket including a first socket portion and a second socket portion, a collar configured to secure the rotator ball within the socket, and a load support coupled to the first socket portion of the socket. Relative rotation of the rotator ball within the collar does not cause loosening of the collar. The socket, collar and load attachment connected thereto is able to rotate freely about the rotator ball attached to the arm.

Embodiment 39 is the rotational joint of embodiment 38, wherein the rotator ball includes a cylindrical opening.

Embodiment 40 is the rotational joint of embodiment 39, wherein the stem of the ball attachment includes a first end that is configured for insert through the cylindrical opening of the rotator ball and into a screw hole of the arm.

Embodiment 41 is the rotational joint of any of embodiments 38-40, wherein the rotator ball and the stem are formed integrally.

Embodiment 42 is the rotational joint of any of embodiments 38-41, wherein the first socket portion is keyed to the second socket portion to prevent relative rotation between the first socket portion and the second socket portion.

Embodiment 43 is the rotational joint of embodiment 42, wherein the collar is configured to tighten the second socket portion to the first socket portion and thereby secure the rotator ball within the socket.

Embodiment 44 is the rotational joint of any of embodiments 38-43, wherein the rotation of the rotator ball does not cause loosening of the collar.

Embodiment 45 is the rotational joint of any of embodiments 38-44, wherein a level of rotation resistance between the socket and the rotator ball is set by the collar.

Embodiment 46 is the rotational joint of any of embodiments 43-45, wherein the collar is configured to engage the second socket portion via interior screw threads of the collar and exterior screw threads of the second socket portion and to engage the first socket portion via a flange.

Embodiment 47 is the rotational joint of embodiment 46, wherein screwing the collar into the second socket portion via the interior screw threads and the exterior screw threads pulls the first socket portion towards the second socket portion via the flange.

Embodiment 48 is a load support unit including a lower arm, a upper arm, a mounting swivel configured to support the lower arm, a swivel joint disposed between the lower arm and a knuckle joint, the knuckle joint disposed between the swivel joint and the upper arm, an outer shell configured to house the swivel joint and the knuckle joint, and a rotational joint configured for supporting a load at the upper arm.

Embodiment 49 is the load support unit of embodiment 48, wherein the lower arm includes a first end and a second end and the upper arm includes a first end and a second end, the mounting swivel is configured to support the first end of the lower arm, the swivel joint is disposed between the second end of the lower arm and the knuckle joint, the knuckle joint is disposed between the swivel joint and the first end of the upper arm, and the rotational joint is configured to support the load at the second end of the upper arm.

Embodiment 50 is the load support unit of embodiment 48 or 49, wherein the mounting swivel further includes a base plate configured for coupling to the lower arm.

Embodiment 51 is the load support unit of embodiment 50, wherein the mounting swivel further includes a holder post extending longitudinally from the base plate, wherein the holder post includes at least one keyway.

Embodiment 52 is the load support unit of embodiment 50 or 51, wherein the mounting swivel further includes a base adapter configured to receive the holder post.

Embodiment 53 is the load support unit of any of embodiments 50-52, wherein the base adapter further includes a base block including a cylindrical cavity defined by a circumferential wall, wherein the base block further includes at least one keyway disposed in the circumferential wall.

Embodiment 54 is the load support unit of any of embodiments 5-53, wherein the base adapter further includes a base socket extending from the base block, the base socket configured to house the holder post of the lower arm.

Embodiment 55 is the load support unit of any of embodiments 50-54, wherein the mounting swivel further includes a friction stack.

Embodiment 56 is the load support unit of any of embodiments 50-55, wherein the friction stack further includes a plurality of clutch plates and a plurality of friction plates disposed between respective ones of the plurality of clutch plates.

Embodiment 57 is the load support unit of any of embodiments 50-56, wherein the mounting swivel further includes a spring element providing a biasing force to the friction stack.

Embodiment 58 is the load support unit of any of embodiments 48-57, wherein the outer shell further includes a tapered interior cavity.

Embodiment 59 is the load support unit of embodiment 58, wherein the swivel joint further includes a first tapered bushing having a first circumferential opening through a center thereof, the first tapered bushing disposed within the tapered interior cavity of the outer shell.

Embodiment 60 is the load support unit of embodiment 58 or 59, wherein the swivel joint further includes a second tapered bushing having a second circumferential opening through a center thereof and configured to rest within a tapered well of the lower arm.

Embodiment 61 is the load support unit of any of embodiments 58-60, wherein the swivel joint further includes a shoulder screw sized and shaped to fit within the tapered interior cavity, the first circumferential opening of the first tapered bushing and the second circumferential opening of the second tapered bushing and configured to engage with a screw hole in the tapered well.

Embodiment 62 is the load support unit of any of embodiments 58-61, wherein the swivel joint further includes a first biasing element configured to bias the first tapered bushing into the tapered interior cavity.

Embodiment 63 is the load support unit of any of embodiments 58-62, wherein the swivel joint further includes a second biasing element configured to bias the second tapered bushing into the tapered well.

Embodiment 64 is the load support unit of any of embodiments 49-63, wherein the knuckle joint further includes a circumferential body sized and shaped to fit within an opening of the first end of the upper arm, the circumferential body having circumferential teeth on an interior surface of the circumferential body.

Embodiment 65 is the load support unit of embodiment 64, wherein the knuckle joint further includes an actuator element.

Embodiment 66 is the load support unit of embodiment 64 or 65, wherein the actuator element further includes a trigger button disposed exterior to the body and having an engagement arm extending therefrom and into the body.

Embodiment 67 is the load support unit of any of embodiments 64-66, wherein the actuator element further includes at least one actuator pawl disposed within the interior surface of the body, the at least one actuator pawl having teeth configured to engage the circumferential teeth of the circumferential body.

Embodiment 68 is the load support unit of any of embodiments 64-67, wherein the actuator element further includes a biasing spring configured to bias the engagement arm away from interaction with the at least one actuator pawl.

Embodiment 69 is the load support unit of any of embodiments 64-68, wherein the actuator element further includes a spring element configured to bias the teeth of the at least one actuator pawl towards the circumferential teeth of the body.

Embodiment 70 is the load support unit of any of embodiments 48-69, wherein the rotational joint further includes a ball attachment.

Embodiment 71 is the load support unit of embodiment 70, wherein the ball attachment further includes a rotator ball and a stem formed integrally with an extending from the rotator ball.

Embodiment 72 is the load support unit of embodiment 70 or 71, wherein the rotational joint further includes a socket configured to accommodate the rotator ball.

Embodiment 73 is the load support unit of any of embodiments 70-72, wherein the socket further includes a first socket portion and a second socket portion.

Embodiment 74 is the load support unit of any of embodiments 70-73, wherein the first socket portion is keyed to the second socket portion to prevent relative rotation between the first socket portion and the second socket portion.

Embodiment 75 is the load support unit of any of embodiments 70-74, wherein the rotational joint further includes a collar configured to secure the rotator ball within the socket, wherein the collar is configured to tighten the first socket portion and the second socket portion and thereby secure the rotator ball within the socket.

Embodiment 76 is the load support unit of any of embodiments 70-75, wherein the rotational joint further includes a load support coupled to the first socket portion of the socket.

Embodiment 77 is the load support unit of any of embodiments 48-76, wherein the mounting swivel is configured to attach to a cart.

1. A knuckle joint configured for connecting a lower arm and a upper arm, the knuckle joint comprising:
an outer shell;
a body sized and shaped to fit within an opening of the upper arm;
an actuator element including:
a trigger button disposed exterior to the body and having an engagement arm extending therefrom and into the body;
at least one actuator pawl disposed within an interior surface of the body;
a biasing spring configured to bias the engagement arm away from interaction with the at least one actuator pawl; and
a spring element configured to bias the at least one actuator pawl towards the interior surface of the body,
wherein when the trigger button is engaged, the engagement arm interacts with the at least one actuator pawl such that the knuckle joint is in an unlocked configuration.

2-12. (canceled)

13. A swivel joint configured for connecting a lower arm and a upper arm, the swivel joint comprising:
an outer shell;
a first tapered bushing having a first circumferential opening through a center thereof,
a second tapered bushing having a second circumferential opening through a center thereof, and
a shoulder screw,
wherein the first tapered bushing is rotationally keyed to the shoulder screw to prevent relative rotation with the shoulder screw and provide friction during relative rotation with the outer shell.

14-22. (canceled)

23. A mounting swivel configured for supporting an arm, the mounting swivel comprising:
a base plate configured for coupling to the arm;
a holder post extending from the base plate, wherein the holder post includes at least one keyway;
a base adapter configured to receive the holder post and including:
a base block, wherein the base block further includes at least one keyway, and
a base socket extending from the base block; and
a friction stack including:
a plurality of clutch plates;
a plurality of friction plates disposed between respective ones of the plurality of clutch plates; and
a spring element,
wherein the base socket of the base adapter is configured to house the holder post of a lower arm,
wherein rotation of the holder post causes conforming rotation of the plurality of friction plates relative to the plurality of clutch plates, and
wherein the rotation of the plurality of friction plates relative to the plurality of clutch plates causes resistance to the rotation of the holder post.

24-37. (canceled)

38. A rotational joint configured for supporting a load at an end of an arm, the rotational joint comprising:
a ball attachment including a rotator ball and a stem,
a socket configured to accommodate the rotator ball, the socket including a first socket portion and a second socket portion,
a collar configured to secure the rotator ball within the socket, and
a load support coupled to the first socket portion of the socket,
wherein relative rotation of the rotator ball within the collar does not cause loosening of the collar, and
wherein the socket, the collar and the load support connected thereto is able to rotate freely about the rotator ball attached to the arm.

39-47. (canceled)

48. A load support unit including:
a lower arm;
a upper arm;
a mounting swivel configured to support the lower arm;
a swivel joint disposed between the lower arm and a knuckle joint;
the knuckle joint disposed between the swivel joint and the upper arm;
an outer shell configured to house the swivel joint and the knuckle joint; and
a rotational joint configured for supporting a load at the upper arm.

49. The load support unit of claim 48, wherein the lower arm includes a first end and a second end and the upper arm includes a first end and a second end, the mounting swivel is configured to support the first end of the lower arm, the swivel joint is disposed between the second end of the lower arm and the knuckle joint, the knuckle joint is disposed between the swivel joint and the first end of the upper arm, and the rotational joint is configured to support the load at the second end of the upper arm.

50. The load support unit of claim 48, wherein the mounting swivel further includes a base plate configured for coupling to the lower arm.

51. The load support unit of claim 50, wherein the mounting swivel further includes a holder post extending longitudinally from the base plate, wherein the holder post includes at least one keyway.

52. The load support unit of claim 51, wherein the mounting swivel further includes a base adapter configured to receive the holder post.

53. The load support unit of claim 52, wherein the base adapter further includes a base block including a cylindrical cavity defined by a circumferential wall, wherein the base block further includes at least one keyway disposed in the circumferential wall.

54. The load support unit of claim 52, wherein the base adapter further includes a base socket extending from the base block, the base socket configured to house the holder post of the lower arm.

55. The load support unit of claim 50, wherein the mounting swivel further includes a friction stack.

56. The load support unit of claim 55, wherein the friction stack further includes a plurality of clutch plates and a plurality of friction plates disposed between respective ones of the plurality of clutch plates.

57. The load support unit of claim 55, wherein the mounting swivel further includes a spring element providing a biasing force to the friction stack.

58. The load support unit of claim 48, wherein the outer shell further includes a tapered interior cavity.

59. The load support unit of claim 58, wherein the swivel joint further includes a first tapered bushing having a first circumferential opening through a center thereof, the first tapered bushing disposed within the tapered interior cavity of the outer shell.

60. The load support unit of claim 59, wherein the swivel joint further includes a second tapered bushing having a second circumferential opening through a center thereof and configured to rest within a tapered well of the lower arm.

61. The load support unit of claim 60, wherein the swivel joint further includes a shoulder screw sized and shaped to fit within the tapered interior cavity, the first circumferential opening of the first tapered bushing and the second circumferential opening of the second tapered bushing and configured to engage with a screw hole in the tapered well.

62. The load support unit of claim 59, wherein the swivel joint further includes a first biasing element configured to bias the first tapered bushing into the tapered interior cavity.

63. The load support unit of claim 60, wherein the swivel joint further includes a second biasing element configured to bias the second tapered bushing into the tapered well.

64. The load support unit of claim 49, wherein the knuckle joint further includes a circumferential body sized and shaped to fit within an opening of the first end of the upper arm, the circumferential body having circumferential teeth on an interior surface of the circumferential body.

65. The load support unit of claim 64, wherein the knuckle joint further includes an actuator element.

66. The load support unit of claim 65, wherein the actuator element further includes a trigger button disposed exterior to the body and having an engagement arm extending therefrom and into the body.

67. The load support unit of claim 65, wherein the actuator element further includes at least one actuator pawl disposed within the interior surface of the body, the at least one actuator pawl having teeth configured to engage the circumferential teeth of the circumferential body.

68. The load support unit of claim 66, wherein the actuator element further includes a biasing spring configured to bias the engagement arm away from interaction with the at least one actuator pawl.

69. The load support unit of claim 65, wherein the actuator element further includes a spring element configured to bias the teeth of the at least one actuator pawl towards the circumferential teeth of the body.

70. The load support unit of claim 48, wherein the rotational joint further includes a ball attachment.

71. The load support unit of claim 70, wherein the ball attachment further includes a rotator ball and a stem formed integrally with and extending from the rotator ball.

72. The load support unit of claim 70, wherein the rotational joint further includes a socket configured to accommodate the rotator ball.

73. The load support unit of claim 72, wherein the socket further includes a first socket portion and a second socket portion.

74. The load support unit of claim 73, wherein the first socket portion is keyed to the second socket portion to prevent relative rotation between the first socket portion and the second socket portion.

75. The load support unit of claim 73, wherein the rotational joint further includes a collar configured to secure the rotator ball within the socket, wherein the collar is configured to tighten the first socket portion and the second socket portion and thereby secure the rotator ball within the socket.

76. The load support unit of claim 73, wherein the rotational joint further includes a load support coupled to the first socket portion of the socket.

77. The load support unit of claim 48, wherein the mounting swivel is configured to attach to a cart.
